(19) United States
(12) Patent Application Publication
(10) Pub. No.: US 2007/0076263 A1
(43) Pub. Date: Apr. 5, 2007

(54) Image printing using order sheet

(75) Inventors: Kenji Matsuzaka, Nagano-ken (JP); Ayahiro Nakajima, Nagano-ken (JP); Seiji Aiso, Nagano-ken (JP)

Correspondence Address: EDWARDS & ANGELL, LLP, P.O. BOX 55874, BOSTON, MA, 02205, US

(73) Assignee: Seiko Epson Corporation, Tokyo (JP)

(21) Appl. No.: 11/541,234

(22) Filed: Sep. 29, 2006

(30) Foreign Application Priority Data
Sep. 30, 2005 (JP) 2005-286199
Aug. 18, 2006 (JP) 2006-223285

(51) Int. Cl. H04N 1/38

(52) U.S. Cl. 358/464; 358/448

(57) ABSTRACT

A printing method for printing an image based on image data, the printing method includes: loading the image data from a storage medium in which the image data is stored; printing an order sheet, wherein the order sheet includes an index image representing the loaded image data to receive from a user entry of information for printing the image; recognizing the information entered on the order sheet via scanning the order sheet; and printing a trim image based on the recognized entered information, wherein the trim image is made by trimming the image.

### CROSS-REFERENCES TO RELATED APPLICATION

This application relates to and claims priority from the following identified Japanese Patent Applications, the entire disclosures of which are incorporated by reference herein.

1. Japanese Patent Application No.P2005-286199, filed on Sep. 30, 2005

2. Japanese Patent Application No.P2006-223285, filed on Aug. 18, 2006

### BACKGROUND

1. Technical Field

The present invention relates to image printing technologies for printing images or graphics.

2. Related Art

For printing a graphic using a printing device based on graphic data that is recorded on a recording medium, there has been a graphic printing technology that produces a print of the graphic using an order sheet. In this order sheet, a mark notation part that receives, through the notation of marks, specifications such as the number of copies of the graphic to print, the print size, and so forth, is printed out along with index graphics that show the graphic data, where the graphic printing is performed through scanning, using the printing device, the order sheet wherein the marks are noted by the user. The graphic printing technology is disclosed in the patent references JP-A-2004-255729, JP-A-2005-111802, JP-A-2005-117328, JP-A-2005-125730 and JP-A-2005-138573.

### SUMMARY

However, in the graphic printing technology, inadequate thought was given to using the order sheet to edit the graphics that will be printed.

Based on the issue described above, an advantage of some aspect of the invention is to provide a graphic printing technology wherein it is possible to increase the convenience of graphic printing using an order sheet.

In order to solve the problem described above, a printing device according to an aspect of the invention is a printing device for printing a graphic based on graphic data, comprising a graphic readout unit for reading out graphic data from a recording medium on which the graphic data is recorded; an order sheet printing control unit for controlling the printout of an order sheet having mark areas that receive, from the user, marked information for printing a graphic using an index graphic that shows the graphic data that has been read out; a scan and sensing unit for sensing marked information that is marked into the mark areas, through scanning the order sheet; and a trimming and printing control unit for controlling the printing of a trimmed graphic wherein the graphic is trimmed based on the marked information that has been sensed. This makes it possible for the printing device to use the order sheet to receive requirements from the user regarding trimming processes on the graphics to be printed. Consequently, it is possible to increase the level of convenience of graphic printing through the use of the order sheet.

The aforementioned printing device can also use the configuration described below. For example, the trimming and printing control unit may be provided with a trimming specifying unit for specifying the portions to be removed from a graphic for the trimmed graphic, based on the marked information that has been sensed. This makes it possible for the printing device to receive, through the order sheet, a specification from the user regarding the portions on the graphic to be trimmed.

Moreover, the scan sensing unit may be provided with a cut line sensing unit for sensing, as marked data, cut lines filled in on the index graphics, where the trimming and printing control unit may be provided with a trimming specifying unit for specifying, as portions to be removed from the graphic for the trimmed graphic, the area outside of the cut lines that are sensed in the index graphics. This makes it possible for the user to use cut lines to intuitively specify the graphic to remain as the trimmed graphic.

Moreover, the scan sensing unit may be provided with a fill-in sensing unit that senses, as marked information, regions on the index graphics that have been filled in, and may be provided with a trimming specification unit that specifies, as a portion to be removed from the graphic for the trimmed graphic, a region that is sensed in the index graphic. This makes it possible for the user to specify intuitively the portion of the graphic to be removed by trimming.

Moreover, the mark areas that are in the order sheet that is printed may have grid-shaped grid lines on the index graphics, where the scan sensing unit may be provided with a grid line sensing unit for sensing, as marked information, line segments that are marked along the grid lines, and the trimming and printing control may be provided with a trimming specifying part for specifying, as portions to be removed from the graphic for the trimmed graphic, the area outside of a rectangle that is indicated by line segments that have been sensed on the index graphic. This makes it possible for the user to specify precisely the part of the graphic to leave behind as the trimmed graphic. Moreover, in such a configuration, the aspect ratio of the rectangle that is surrounded by the grid lines may be the same aspect ratio as that of the trimmed graphic that will be printed. This makes it possible to maintain, at an appropriate value, the aspect ratio of the trimmed graphic to be printed through keeping an identical number of rectangles in the horizontal and vertical directions (for example, having the “number of rectangles in the horizontal direction” x “number of rectangles in the vertical direction” be “2×2,” “3×3,” or some other value of “n×n (where n is a whole number)”).

Moreover, the mark areas in the order sheet that is printed may have a ruler on the index graphics, where the scan sensing unit may be provided with a tick mark sensing unit for sensing, as marked information, tick marks marked on the ruler, and where the trimming and printing control unit may be provided with a trimming specifying unit that specifies, as the portions to be removed from the graphic for the trimmed graphic, regions corresponding to the tick marks that are sensed in the index graphics. This makes it possible for the user to specify precisely the position on the graphic to be removed through trimming.

Moreover, the mark areas in the order sheet that is printed may have two mutually perpendicular rulers on the index graphics, where the scan sensing unit may be provided with a tick mark sensing unit for sensing, as marked information, the two sets of tick marks that are each filled in on the aforementioned two rulers, and where the trimming and printing control unit may be provided with a trimming specifying unit for specifying, as the portions to be removed from the graphic for the trimmed graphic, the area outside of a rectangle included in perpendicular lines extending from each of the two sets of tick marks that have been sensed on the index graphics. This makes it possible for the user to specify with precision the portions on the graphic to be left as the trimmed graphic.

Moreover, the mark areas that are on the order sheet that is printed may have a plurality of trimming patterns indicating candidates as trimming graphics, on the index graphics, and a plurality of mark notation parts for receiving, from the user, mark notations corresponding to the plurality of trimming patterns, where the scan sensing unit may be provided with a mark sensing unit for sensing, as marked information, marks that have been notated in the plurality of mark notation parts, and where the trimming and printing control unit may be provided with a trimming specifying unit for specifying, as portions to be removed from the graphic for the trimmed graphic, the outside of a trimming pattern corresponding to a mark notation part for which a mark has been sensed. This makes it possible for the user to specify easily the portions on the graphic to remain as the trimmed graphic.

Moreover, in the configuration described above wherein marked information is notated on an index graphic, the order sheet printing control unit may be provided with a graphic adjusting unit for adjusting the brightness and/or saturation of the index graphic depending on the sensing precision of the marked information. This makes it possible to sense the marked information on the index graphic easily when the order sheet is scanned and the marked information is sensed.

Moreover, the order sheet printing control unit may be provided with a though adjusting unit for thinning out the printing dots that comprise the index graphic. This makes it possible to sense the marked information on the index graphic easily when the order sheet is scanned and the marked information is sensed. Note that the print dot thinning process may be achieved through generating print data for an index graphic wherein the print dots have been thinned, or may be achieved through controlling the jets of printing ink when printing the index graphic.

Moreover, the trimming and printing control unit may be provided with a warning unit for producing a warning when the aspect ratio and/or size of the trimmed graphic vary from a reference value. This makes it possible to prevent the printing of a trimmed graphic wherein the trimming was performed unsuitably.

Moreover, the trimming and printing control unit may be provided with a correcting unit that corrects the aspect ratio and/or size of the trimmed graphic based on a reference value. This makes it possible to print a trimmed graphic wherein the trimming has been performed suitable.

Moreover, the scan sensing unit may sense the marked information based on a chromatic difference between the order sheet at the time of the aforementioned printing and the order sheet at the time of scanning. This makes it possible to improve the sensing accuracy of the marked information.

Furthermore, the scan sensing unit may sense the marked information based on a specific color that is notated on the order sheet at the time of scanning. This makes it possible to increase the sensing accuracy of the marked information when a writing implement to be used when notating the marked information is provided in advance. In this case, the specific color may be a color that is difficult to express with the printing ink that is used in the printing device, such as, for example, a fluorescent color, a metallic color (gold or silver), or the like.

Moreover, the trimming and printing control unit may be provided with a display control unit for controlling the display of the trimmed graphic to a display prior to the printing of the trimmed graphic, and a correction receiving unit for receiving corrections to the trimmed graphic from the user prior to the printing of the trimmed graphic. This makes it possible for the user to specify trimming adjustments in greater detail.

Moreover, the form of the aspect of the invention is not limited to a printing device, but rather may be applied to, for example, a printing method for printing a graphic, based on graphic data, using a printing device, a program for achieving, in the computer of a printing device, functions for printing a graphic based on graphic data, a computer system comprising a personal computer, a printing device, and a scanner device, and so forth. Furthermore, the aspect of invention is not limited to the forms described above, and may naturally be realized in various forms that fall within the essential scope thereof.

### BRIEF DESCRIPTION OF THE DRAWINGS

The invention will be described with reference to the accompanying drawings, wherein like numbers reference like elements.

FIG. 1 shows an oblique view illustrating the external configuration of a printing device 10.

FIG. 2 shows an explanatory diagram illustrating the internal configuration of the printing device 10.

FIG. 3 shows a flow chart illustrating the graphic printing process executed by a main control unit 110 of the printing device 10 according to a first example of embodiment.

FIG. 4 shows an explanatory diagram illustrating an example of an order sheet 910 that is printed by the printing device 10 in the first example of embodiment.

FIG. 5 shows an explanatory diagram illustrating an example of an order sheet 910 of FIG. 4 wherein information for printing the graphic in the first example of embodiment has been marked by the user.

FIG. 6 shows an explanatory diagram illustrating the state wherein the cut line CL is sensed.

FIG. 7 shows an explanatory diagram illustrating the state wherein a cut portion CP is specified and the state wherein a trimmed graphic TG is printed.

FIG. 8 shows an explanatory diagram illustrating a print index graphic IGp according to a modified example.

FIG. 9 shows an explanatory diagram illustrating an order sheet 912 according to a modified example.

FIG. 10 shows an explanatory diagram illustrating the state wherein a cut line CL is sensed in a modified example.

FIG. 11 shows an explanatory diagram illustrating the state wherein a cut portion CP is specified in a modified example, and the state wherein a trimmed graphic TG is printed in the modified example.

FIG. 12 shows an explanatory diagram illustrating the state wherein a cut portion CP is specified in a modified example, and the state wherein a trimmed graphic TG is printed in the modified example.

FIG. 13 shows a flow chart illustrating a graphic printing process is a modified example.

FIG. 14 shows a flow chart illustrating a graphic printing process that is executed by a main control unit 110 of a printing device 10 in a second example of embodiment.

FIG. 15 shows an explanatory diagram illustrating an example of the order sheet 910 of FIG. 4, wherein the user has marked information for printing the graphic, in the second example of embodiment.

FIG. 16 shows an explanatory diagram illustrating the state wherein a cut portion CP has been specified in the second example of embodiment, and the state wherein a trimmed graphic TG has been printed in the second example of embodiment.

FIG. 17 shows a flow chart illustrating a graphic printing process that is performed by a main control unit 110 of a printing device 10 in a third example of embodiment.

FIG. 18 shows an explanatory diagram illustrating an example of an order sheet 930 printed by the printing device 10 in the third example of embodiment.

FIG. 19 shows an explanatory diagram illustrating an example of the order sheet 930 in FIG. 18, wherein information for printing the graphic has been filled in by the user in the third example of embodiment.

FIG. 20 shows an explanatory diagram illustrating the state wherein a cut portion CP has been specified in the third example of embodiment, and the state wherein a trimmed graphic TG has been printed in the third example of embodiment.

FIG. 21 shows a flow chart illustrating a graphic printing process that is performed by a main control unit 110 of a printing device 10 in a fourth example of embodiment.

FIG. 22 shows an explanatory diagram illustrating an example of an order sheet 940 printed by the printing device 10 in the fourth example of embodiment.

FIG. 23 shows an explanatory diagram illustrating an example of the order sheet 940 in FIG. 22, wherein information for printing the graphic has been filled in by the user in the fourth example of embodiment.

FIG. 24 shows an explanatory diagram illustrating the state wherein a cut portion CP has been specified in the fourth example of embodiment, and the state wherein a trimmed graphic TG has been printed in the fourth example of embodiment.

FIG. 25 shows a flow chart illustrating a graphic printing process that is performed by a main control unit 110 of a printing device 10 in a fifth example of embodiment.

FIG. 26 shows an explanatory diagram illustrating an example of the order sheet 940 in FIG. 22, wherein information for printing the graphic has been filled in by the user in the fifth example of embodiment.

FIG. 27 shows an explanatory diagram illustrating the state wherein a cut portion CP has been specified in the fifth example of embodiment, and the state wherein a trimmed graphic TG has been printed in the fifth example of embodiment.

FIG. 28 shows a flow chart illustrating a graphic printing process that is performed by a main control unit 110 of a printing device 10 in a sixth example of embodiment.

FIG. 29 shows an explanatory diagram illustrating an example of an order sheet 960 printed by the printing device 10 in the sixth example of embodiment.

FIG. 30 shows an explanatory diagram illustrating an example of the order sheet 960 in FIG. 29, wherein information for printing the graphic has been filled in by the user in the sixth example of embodiment.

FIG. 31 shows an explanatory diagram illustrating the state wherein a cut portion CP has been specified in the sixth example of embodiment, and the state wherein a trimmed graphic TG has been printed in the sixth example of embodiment.

FIG. 32 shows a flow chart illustrating a graphic printing process that is performed by a main control unit 110 of a printing device 10 in a seventh example of embodiment.

FIG. 33 shows an explanatory diagram illustrating an example of an order sheet 970 printed by the printing device 10 in the seventh example of embodiment.

FIG. 34 shows an explanatory diagram illustrating an example of the order sheet 970 in FIG. 33, wherein information for printing the graphic has been filled in by the user in the seventh example of embodiment.

FIG. 35 shows an explanatory diagram illustrating an example of a printing medium 900 on which a graphic is printed in a state wherein borders are used.

FIG. 36 shows a flow chart illustrating a graphic printing process that is performed by a main control unit 110 of a printing device 10 in an eighth example of embodiment.

FIG. 37 shows an explanatory diagram illustrating an example of an order sheet 980 printed by the printing device 10 in the eighth example of embodiment.

FIG. 38 shows an explanatory diagram illustrating an example of the order sheet 980 in FIG. 37, wherein information for printing the graphic has been filled in by the user in the eighth example of embodiment.

### DESCRIPTION OF EXEMPLARY EMBODIMENTS

In order to provide a greater understand of the structures and actions of the invention as described above, the invention will be explained in the following sequence regarding the applicable graphic printing technologies.

Contents:

A. First Example of Embodiment

(Specifying the trimming region using cut lines)

A-1. Structure of the Printing Device

A-2. Action of the Printing Device

A-3. Modified Examples;

B. Second Example of Embodiment

(Specifying the trimming region through filling in);

C. Third Example of Embodiment

(Specifying the trimming region using grid lines);

D. Fourth Example of Embodiment

(Specifying the trimming region using rulers);

E. Fifth Example of Embodiment

(Specifying the trimming region using rulers);

F. Sixth Example of Embodiment

(Specifying a trimming region using trimming patterns);

G. Seventh Example of Embodiment

(Specifying performance of trimming);

H. Eighth Example of Embodiment

(Specifying borderless printing);

I. Other Examples of Embodiment.

### A. First Example of Embodiment

(Specifying the Trimming Area Using Cut Lines)

### A-1. Structure of the Printing Device

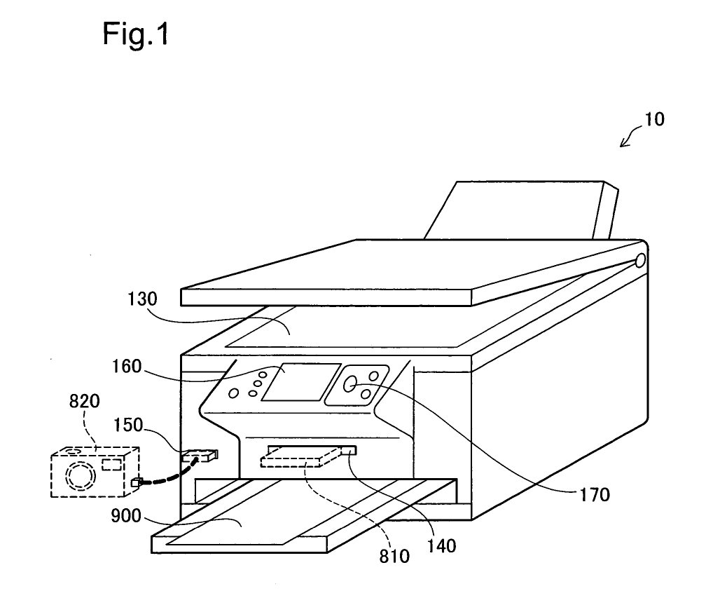

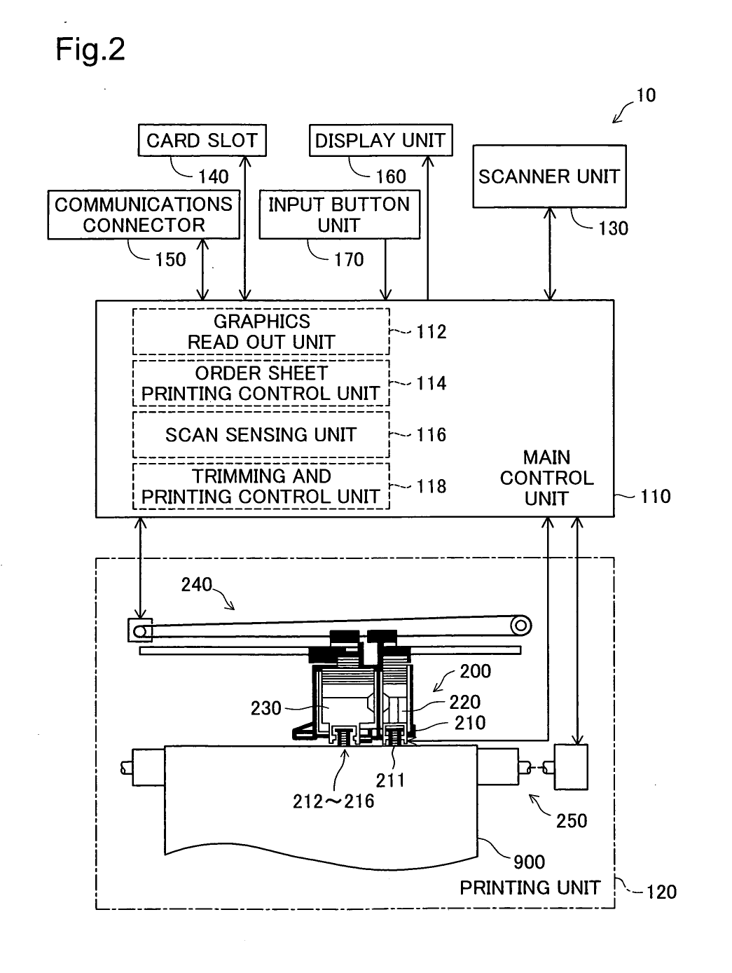

FIG. 1 is an oblique view showing the external structure of a printing device 10. FIG. 2 is an explanatory diagram illustrating the internal structure of the printing device 10. The printing device 10, shown in FIG. 1 and FIG. 2, is a so-called composite device having the functions of a color printer, a monochrome printer, a scanner, a copier, and so forth. The printing device 10 has an order sheet print function that is a function for using an order sheet to print an image or a graphic that is stored on a recording medium connected to the printing device 10.

The printing device 10 is provided with a main control unit 110 that controls each of the parts of the printing device 10; a printing unit 120 that prints onto a printing medium 900 such as ordinary paper, photographic paper, postcards, and so forth; a scanner unit 130 that perform scanning (that is, that reads in a graphic from on a paper and converts the graphic into digital data); a card slot 140 that can read/write data to/form a recording medium 810, such as a memory card containing flash memory, a communications connector 150 capable of exchanging data with an external device 820 that has built-in recording medium, such as a personal computer, a digital still camera, or a digital video camera; a display unit 160 for displaying text and graphics; and an input button unit 170 for receiving instruction inputs from the user of the printing device 10.

The main control unit 110 of the printing device 10 comprises a graphic readout unit 112 for reading out graphic data from the external device 820 that is connected to the communications connector 150, or from a recording medium 810 that is connected to the card slot 140; an order sheet printing control unit 114 for controlling the printing of the order sheet after receiving, from the user, marks for information for printing the graphic based on the graphic data that has been read out; a scan sensing unit 116 for scanning the order sheet to sense the marked information that is notated by the user; and a trimming and printing control unit 118 for controlling the printing of a trimmed graphic wherein a graphic is trimmed based on the marked information that has been sensed.

In the present example of embodiment, the main control unit 110 is an ASIC (application specific integrated circuit) provided with hardware such as a central processing unit (CPU) a read-only memory (ROM), and a random access memory (RAM), where the main control unit 110 is installed with software for producing the various functions of the graphic readout unit 112, the order sheet printing control unit 114, the scan sensing unit 116, and the trimming and printing control unit 118. The action of the main control unit 110 will be described in detail below.

The printing unit 120 of the printing device 10, as shown in FIG. 2, is provided with a print head unit 220 that sprays printing ink onto the printing medium 900, a carriage 200 on which the print head unit 210 is mounted, a carriage driving unit 240 for driving the carriage 200 in the primary scan direction, and a printing medium conveying unit 250 for conveying the printing medium 900. The print head unit 210 of the printing unit 120 has a total of 6 ink spray heads 211 through 216, for the respective black, cyan, light cyan, magenta, light magenta, and yellow-colored inks. Each of the ink spray heads 211 through 216 spray ink on the printing medium 900 through controlling the voltage of the respective piezoelectric (not shown). The printing on the printing medium 900 is achieved through the coordinated action of the ink spray heads 211 through 216 of the printing unit 120, the carriage driving unit 240, and the printing medium conveying unit 250, based on the instructions of the main control unit 110.

### A-2. Action of the Printing Device

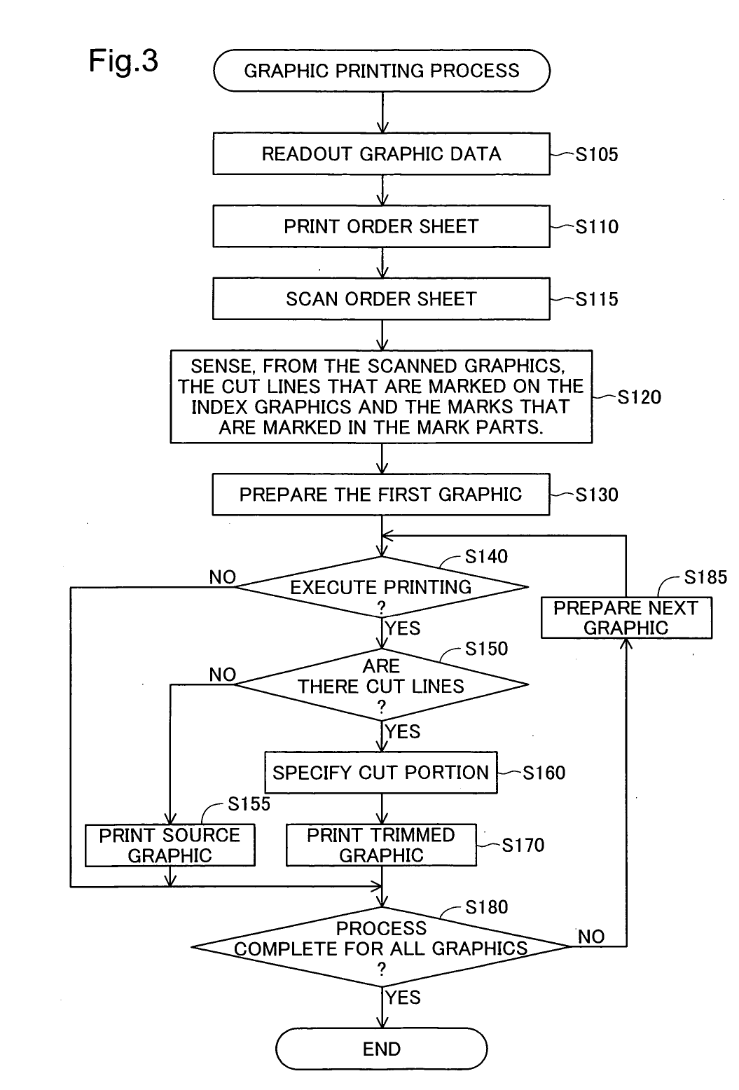

FIG. 3 is a flow chart illustrating the graphic printing process that is performed by the main control unit 110 of the printing device 10 in a first example of embodiment. The main control unit 110 of the printing device 10 starts the graphic printing process in FIG. 3 when a recording medium 810 or external device 820 is attached by the user to a card slot 140 or a communications connector 150, and an order sheet print function execution request is inputted by the user through the input button unit 170.

When the graphic printing process shown in FIG. 3 is started, the main control unit 110 of the printing device 10 reads out the graphic data from the recording medium 810 or the external device 820 that is connected to the card slot 140 or the communications connector 150 (Step S105). Thereafter, the main control unit 110 sends an instruction to the printing unit 120 to print an order sheet based on the graphic data that has been read out (Step S110), and the order sheet is printed thereby.

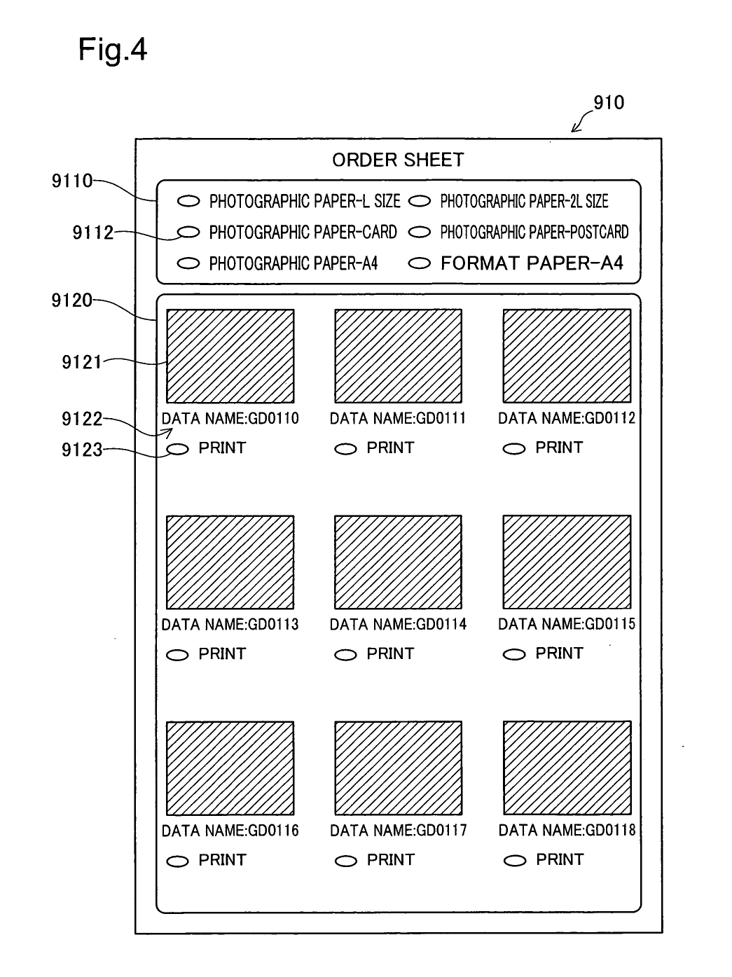

FIG. 4 is an explanatory diagram illustrating one example of an order sheet 910 that is printed by the printing device 10 according to a first example of embodiment. The order sheet 910 of FIG. 4 has a printing paper specifying area 9110, which is a mark area for the receiving, from the user, the notation of information for specifying the type of printing paper on which the graphic will be printed, based on the graphic data, and a printing status specifying area 9120, which is a mark area for receiving, from the user, the marking of information for specifying the printing status for each individual graphic, based on the graphic data.

The printing paper specifying area 9110 of the order sheet 910 has a plurality of mark-parts 9112 corresponding to a plurality of types of printing paper, where these mark parts 9112 receive, from the user, marks specifying the type of printing paper on which to print the graphic based on the graphic data. In the present example of embodiment, the plurality of mark parts 9112 are elliptical shapes that are white on the inside. In the present example of embodiment, there is text indicating the type of the corresponding printing paper for each of the plurality of mark parts 9112. In the example shown in FIG. 4, the individual mark parts 9112 have, as the corresponding types of printing paper, “PHOTOGRAPHIC PAPER—L SIZE” indicating photographic paper for producing a photographic graphic of the regular print size, “PHOTOGRAPHIC PAPER—2 L SIZE” indicating photographic paper of the 2-L size, “PHOTOGRAPHIC PAPER—CARD” indicating photographic paper of a credit card size, “PHOTOGRAPHIC PAPER—POSTCARD” indicating photographic paper of a postcard size, “PHOTOGRAPHIC PAPER—A4” indicating photographic paper of the A4 size, and “FORMAT PAPER—A4” indicating printing paper of the A4 size, which is the standard setting, as the respective types of printing paper.

The printing status specifying area 9120 of the order sheet 910 has data names 9122 that are identifiers that identifies each of the graphic data that are read out, index graphics 9121 that show graphics based on each of the graphic data, and mark parts 9123 for receiving, from the user, mark that indicate whether or not to print the graphics based on these corresponding graphic data. In the present example of embodiment, the plurality of mark parts 9123 are elliptical shapes that are white on the inside. In the present example of embodiment, the graphic quality of the index graphics 9121 are the same graphic quality as the graphics that are printed out based on the graphic data thereof.

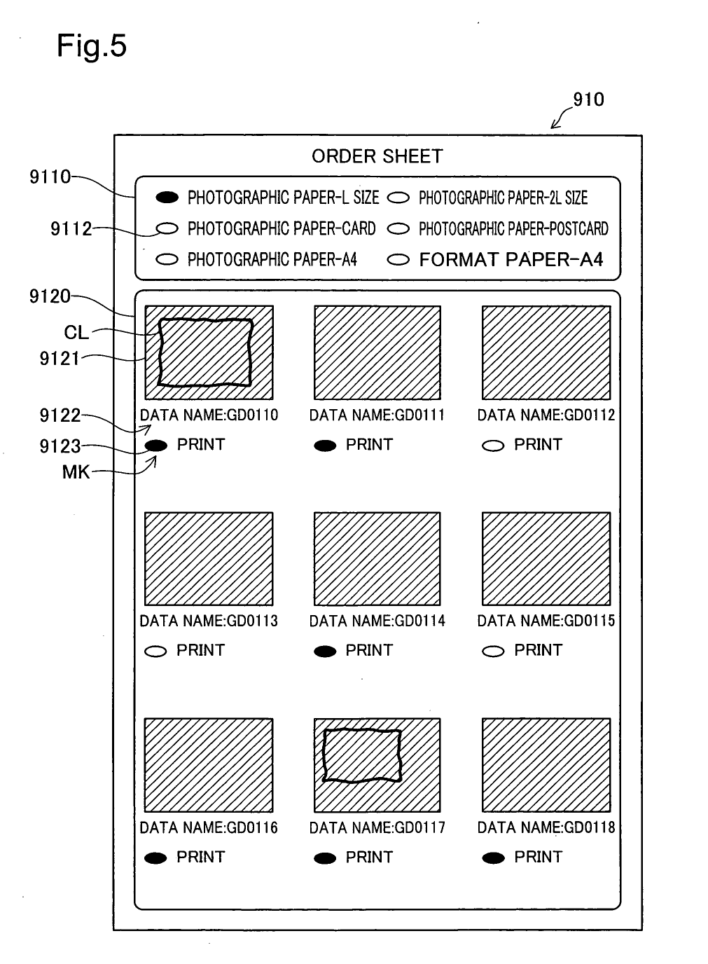

FIG. 5 is an explanatory diagram illustrating one example of an order sheet 910 of FIG. 4, wherein information is marked by the user for printing a graphic in the first example of embodiment. The order sheet 910 of FIG. 5 has, as information that is marked by the user for printing the graphic, a mark MK wherein the insides of one of the plurality of mark parts 9112 of the printing paper specifying area 9110 is filled in, a mark MK wherein the inside of several of the plurality of mark parts 9123 of the printing status specifying area 9120 are filled in, and cut lines CL drawn so as to encompass, with lines, regions on several of the plurality of index graphics 9121 of the printing status specifying area 9120.

In the example shown in FIG. 5, the printing paper specifying area 9110 has a mark MK marked in the mark part 9112 corresponding to “PHOTOGRAPHIC PAPER—L SIZE,” marks MK in the mark parts 9123 corresponding to the graphic data identified as the data names “GD0110,” “GD0111,” “GD0114,” “GD0116,” “GD0117,” and “GD0118,” and, of those graphic data, there are cut lines CL marked in the index graphics 9121 corresponding to the graphic data identified as “GD0110” and “GD0117.”

Returning to the explanation of FIG. 3, after the order sheet 910 shown in FIG. 4 has been printed (Step S110), then the order sheet 910 shown in FIG. 5 is placed by the user in the scanner unit 130 of the printing device 10, and when a scan request for the order sheet 910 shown in FIG. 5 is inputted by the user through an input button unit 170, the main control unit 110 of the printing device 10 acquires, from the scanner unit 130, the scanned graphic that is a scan of the order sheet 910 through applying, to the scanner unit 130, an instruction to scan the order sheet 910 that has been placed therein (Step S115).

Thereafter, the main control unit 110 senses, from the scanned graphics obtained from the scanner unit 130, the mark MK that is marked in the mark part 9112 of the printing paper specifying area 9110, the marks MK that are marked in the mark part 9123 of the printing status specifying area 9120, and the cut lines CL that are marked in the index graphics 9121 of the printing status specifying area 9120 (Step 120).

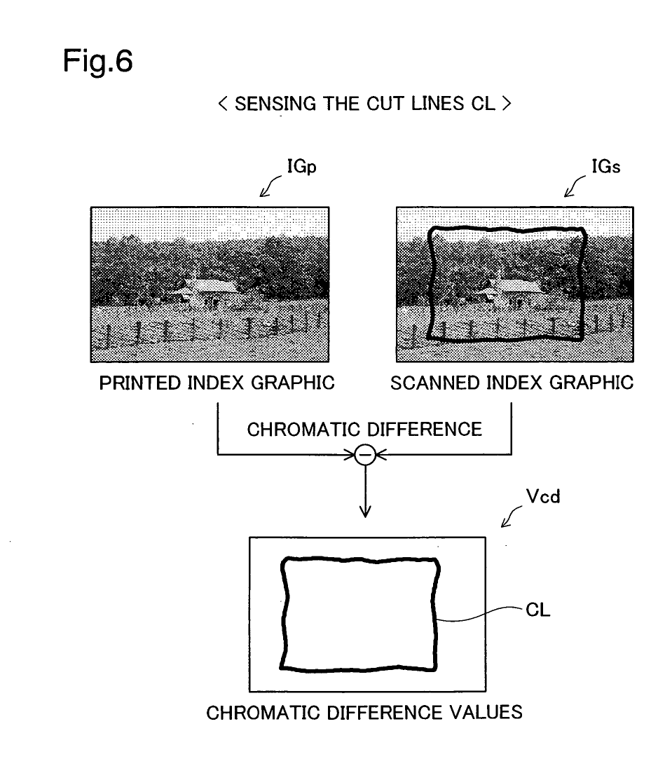

FIG. 6 is an explanatory diagram illustrating the state wherein the cut lines CL are sensed. In the present example of embodiment, the main control unit 110 of the printing device 10 senses, as the cut lines CL, the shape that is indicated by a calculated chromatic difference values Vcd by calculating the chromatic difference values Vcd between the print index graphic IGp that is the index graphic 9121 when the order sheet 910 is printed (Step S110) and the scanned index graphic IGs that is the index graphic 9121 when the order sheet 910 is scanned (Step S115). Note that in the present example of embodiment, the sensing is based on the chromatic difference values Vcd for the marks MK marked in the mark parts 9112 of the printing paper specifying area 9110, and the mark parts 9123 of the printing status specifying area 9120 as well, in the same manner as sensing the cut lines CL on the index graphics 9121.

Returning to the explanation in FIG. 3, after sensing the marks MK and the cut lines CL from the scanned graphics (Step S120), the main control unit 110 of the printing device 10 performs the preparation for printing the first graphic in the sequence shown in the order sheet 910 (Step S130), after which a decision is made as to whether or not to print the prepared graphics (Step S140). In the present example of embodiment, the decision is to print the prepared graphics when it is sensed that a mark MK is marked in the mark part 9123 corresponding to the prepared graphic, in the printing status specifying area 9120 of the scanned order sheet 910.

When it has been confirmed that the prepared graphic shall be printed (Step S140), then the main control unit 110 determines whether or not a cut line CL has been sensed from on the index graphic 9121 corresponding to the graphic that has been prepared (Step S150).

If it is determined that a cut line CL has been sensed from on the index graphic 9121 (in Step S150), then the main control unit 110 specifies a cut portion CP that is a portion that is cut from the source graphic SG for the trimmed graphic TG, as the preparation for printing the trimmed graphic TG wherein the source graphic SG, which is drawn directly from the graphic data that has been read out, is trimmed (Step S160). After this, the main control unit 110 provides instructions to the printing unit 120 for printing the trimmed graphic TG based on the cut portion CP that has been specified (Step S170), thereby printing the trimmed graphic TG.

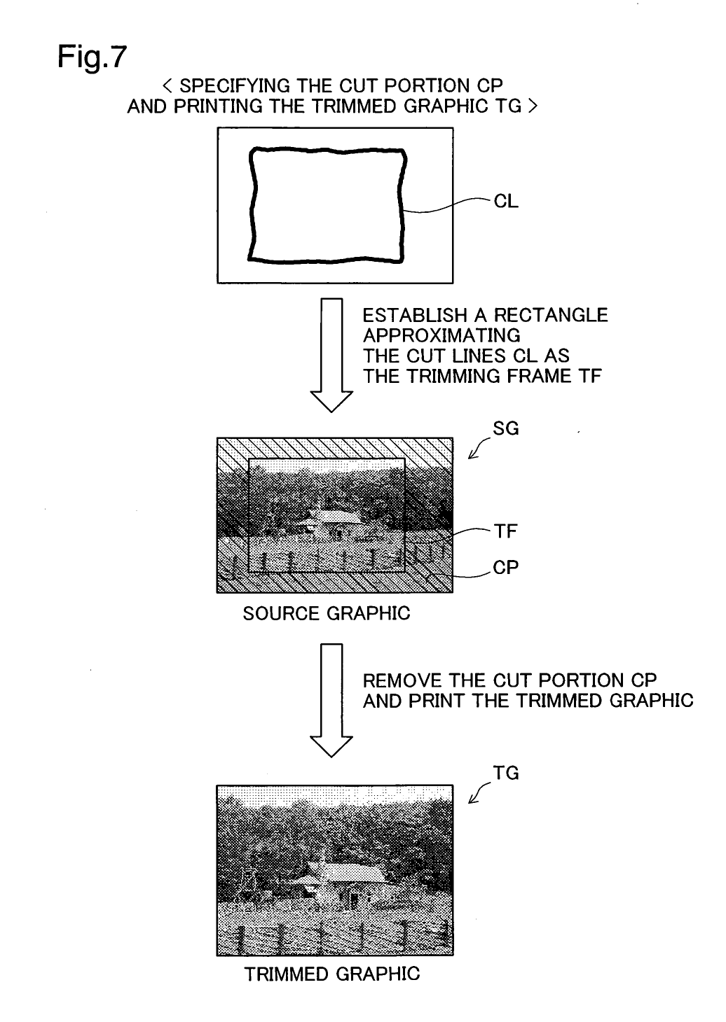

FIG. 7 is an explanatory diagram illustrating the state wherein a cut portion CP has been specified and the state wherein a trimmed graphic TG has been printed. In the present example of embodiment, the main control unit 110 of the printing device 10 sets a rectangle that approximates the specified cut lines CL as a trimming frame TF that demarcates the region of the source graphic SG that will be printed as the trimmed graphic TG, and defines, as the cut portion CP, that which is outside of this trimming frame TF (Step S160). Following this, the main control unit 110 prints, onto the specified printing paper, the trimmed graphic TG, wherein the cut portion CP has been removed from the source graphic SG, doing so at a size that matches that of the printing paper that is specified in the printing paper specifying area 9110 (Step S170).

Note that in the present example of embodiment, the trimming frame TF is established as a rectangle that approximates the cut lines CL with an aspect ratio that is set in advance, but in another example of embodiment, the rectangle that approximates the cut lines CL does not need to have an aspect ratio that is set in advance, but rather the region on the source graphic that is shown by the trimming frame TF may be expanded or reduced so as to produce the aspect ratio that is set in advance.

Returning to the explanation of FIG. 3, when it has been determined that no cut lines CL are sensed from on the index graphic 9121 (Step S150), then the main control unit 110 prints, to the specified printing paper, the source graphic SG, which is drawn directly from the graphic data that is read out, doing so with a size that matches the printing paper that is specified in the printing paper specifying areas 9110 (Step S155).

The main control unit 110 ends the graphic printing process of FIG. 3 after performing the processes described above for all of the graphics indicated on the order sheet (Step S180 and Step S185). Note that the graphic that is printed when printing the source graphic SG (Step S155) or when printing the trimmed graphic TG (Step S170) may undergo graphic corrections for contrast, sharpness, brightness, color temperature, color density, hue, etc., depending on the information that is shown at the time at which the photograph is taken, which is appended to the graphic data that shows the graphic itself, and depending on the quality of the graphic.

Given the graphic printing technology in the first example of embodiment described above, the printing device 10 is able to use the order sheet 910 to receive requirements from the user pertaining to the trimming process for the graphics to be printed. Moreover, the user is able to use cut lines CL to intuitively specify portions on the source graphic SG to remain as the trimmed graphic TG. Consequently, in the graphic printing technology according to the first example of embodiment, it is possible to improve the convenience of the graphic printing through using an order sheet.

### A-3. Modified Example

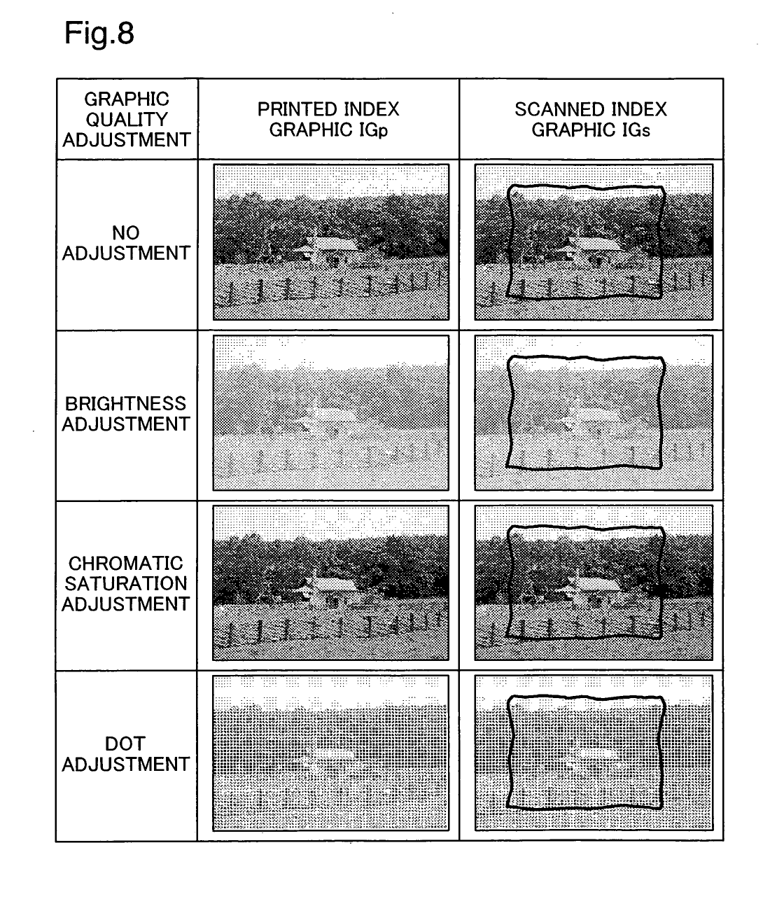

While a first example of embodiment according to the invention was described above, the invention is in nowise limited to the example of embodiment described above, but rather, of course, can be embodied in a variety of forms within a scope that does not deviate from the spirit or intention of the invention. For example, while the graphic quality of the printed index graphic IGp in the first example of embodiment has the same graphic quality as the graphic when printed, instead the main control unit 110 of the printing device 10 may adjust the graphic quality of the printed index graphic IGp depending on the sensing accuracy for the cut lines CL from on the scanned index graphic IGs (Step S120) when printing the order sheet (Step S110). FIG. 8 is an explanatory diagram illustrating a printed index graphic IGp. The state of graphic quality adjustment, the printed index graphic IGp for which the graphic quality has been adjusted, and the scanned index graphic IGs are illustrated in FIG. 8. The unadjusted state, wherein no adjustment has been made to the graphic quality, is shown in the first row in FIG. 8, the state wherein the brightness has been adjusted is shown in the second row in FIG. 8, the state wherein the color saturation has been adjusted is shown in the third row in FIG. 8, and the state wherein the printed dots that comprise the printed index graphic IGp have been thinned is shown in the fourth row in FIG. 8. Note that if the adjustment of the graphic quality wherein the printed dots are thinned, this may be achieved through either having the main control unit 110 of the printing device 10 produce graphic data for the printed index graphic IGp wherein the printed dots have been thinned, or may be achieved by controlling directly the on/off of the printing ink when printing the printed index graphic IGp. These modified examples make it easier to sense the cut lines CL on the scanned index graphic IGs.

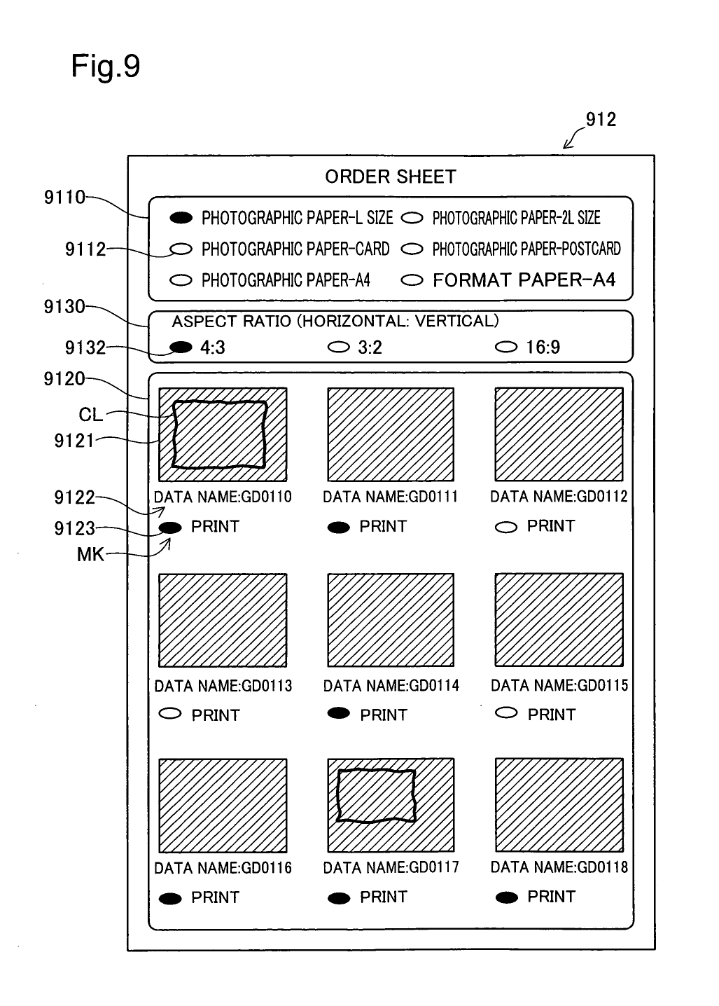

Moreover, while in the first example of embodiment, the trimming frame TF was established with an aspect ratio that was set in advance, instead the trimming frame TF may be set with an aspect ratio that is specified on the order sheet. FIG. 9 is an explanatory diagram illustrating an order sheet 912 according to a modified example. The order sheet 912 of FIG. 9 has aspect ratio specifying areas 9130, which are mark areas for receiving, from the user, marks for information for specifying the aspect ratio of the trimming frame TF, and is otherwise the same as the order sheet 910 in FIG. 4. The aspect ratio specifying areas 9130 on the order sheet 912 have a plurality of mark parts 9132 that correspond to a plurality of aspect ratios, where these mark parts 9132 are, in the present example of embodiment, a plurality of mark parts 9132 that are elliptical shapes that are white on the inside, and receive, from the user, a mark MK that specify the aspect ratio of the trimming frame TF. In the example illustrated in FIG. 9, the text “4:3”, “3:2” and “16:9” are associated with the respective mark parts 9132 as the corresponding trimming frame TF aspect ratios. This makes it possible for the user to specify the desired aspect ratio on the order sheet.

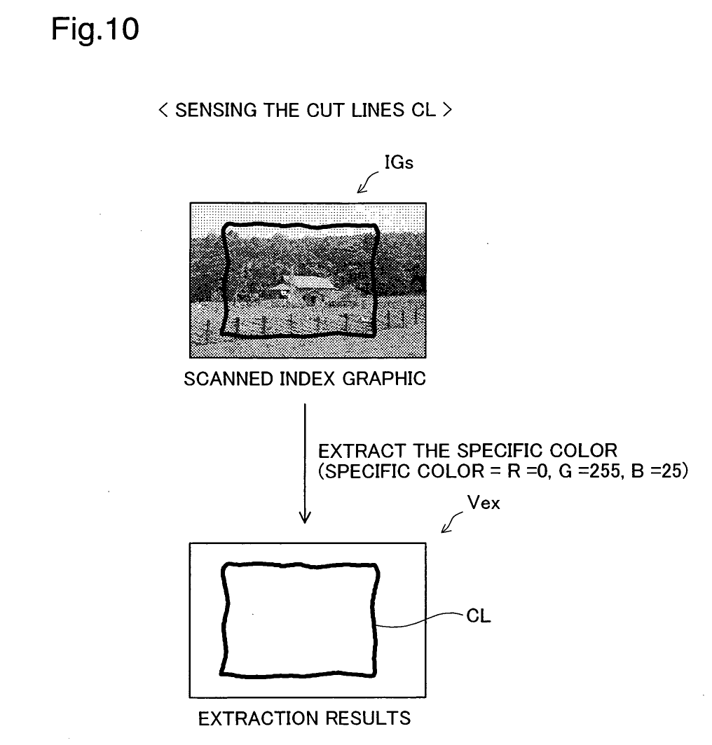

Moreover, while in the first example of embodiment, the sensing of the cut lines CL (in Step S120) was performed by calculating chromatic difference values Vcd between the printed index graphic IGp and the scanned index graphic IGs (FIG. 6), instead this may be performed through extracting specific colors from the scanned index graphic IGs. FIG. 10 is an explanatory diagram illustrating the state wherein the cut lines CL are sensed in a modified example. In the example shown in FIG. 10, the main control unit 110 of the printing device 10 extracts, from the scanned index graphic IGs, a specific color that has been established in advance, to sense, as the cut lines CL, the shape that is shown by the extraction results Vex. This makes it possible to increase the sensing accuracy of the cut lines CL when a writing implement to be used for marking the cut lines CL is established in advance. In this case, a color that is difficult to reproduce with the printing ink that is used in the printing device 10, such as, for example, a fluorescent color or a metallic color (gold or silver), or the like, is appropriate as the specific color. Note that the sensing may be performed based on the extraction results Vex for the marks MK that are marked in the mark parts 9112 for the printing paper specifying areas 9110, and that are marked in the mark parts 9123 of the printing status specifying areas 9120, in the same manner as for sensing the cut lines CL on the index graphics 9121.

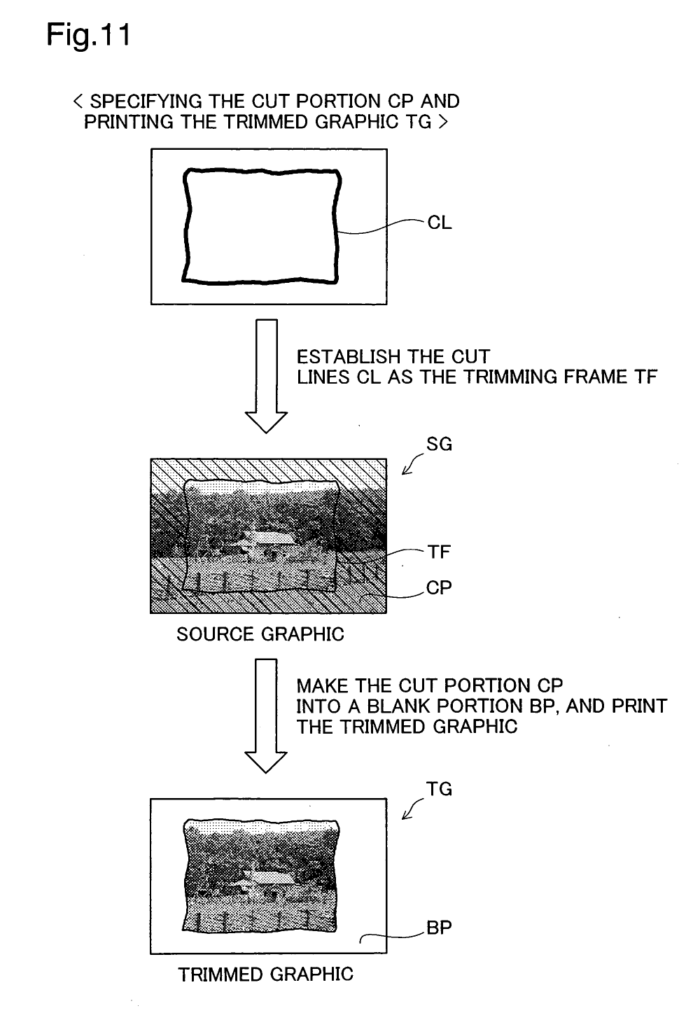

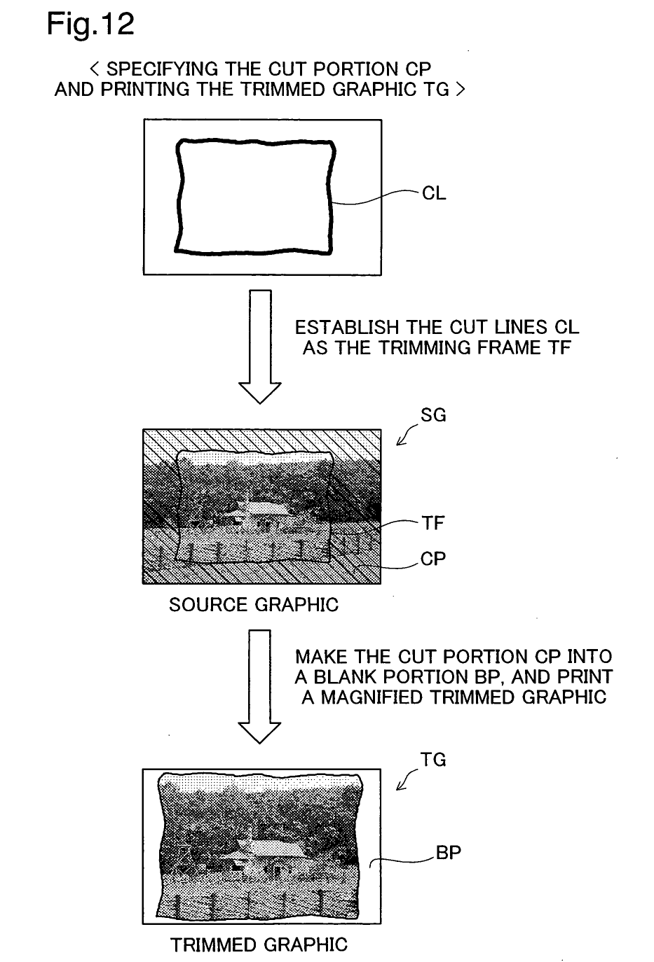

Moreover, while in the first example of embodiment the trimmed graphic TG was established as a rectangle that approximates the cut lines CL (FIG. 7), the graphic may be established in the shape of the cut lines CL themselves. FIG. 11 and FIG. 12 are explanatory diagrams illustrating the state wherein a cut portion CP has been specified in a modified example, and the state wherein the trimming graphic TG has been printed in the modified example. In the example shown in FIG. 11, the main control unit 110 of the printing device 10 establishes the specified cut lines CL as the trimming frame TF, and specifies, as the cut portion CP, the outside of this trimming frame TF (Step S160). Following this, the main control unit 110 prints, to the specified printing paper, a trimmed graphic TG wherein the cut portion CP of the source graphic SG has been replaced with a blank portion BP, at a size that is appropriate to the printing paper that is specified in the printing paper specifying areas 9110 (Step S170). In the example shown in FIG. 12, the main control unit 110 specifies the cut portion CP in the same manner as in FIG. 11 (Step S160), and prints to the specified printing paper a trimmed graphic TG wherein the cut portion CP of the source graphic SG has been replaced with a blank portion BP, at a size that is appropriate for the printing paper specified in the printing paper specifying areas 9110 (Step S170). Note that in these modified examples, the frame CL need not necessarily be rectangular, but instead may be a triangular shape, a circular shape, a star shape, or any other free shape. Moreover, in these modified examples, the blank portion BP may be patterned.

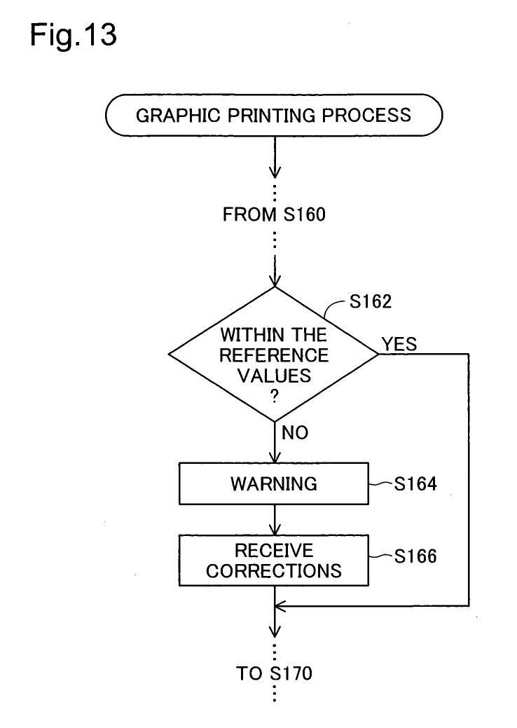

Moreover, the main control unit 110 of the printing device 10 may determine the appropriateness of the trimmed graphic TG after the cut portion CP has been specified (Step S160). FIG. 13 is a flow chart illustrating the graphic printing process in a modified example. The main control unit 110 of the printing device 10 determines whether or not a reference value, which has been set in advance, is fulfilled by the trimmed graphic TG after (Step 162) the cut portion CP has been specified (Step S160). The reference values for determining the appropriateness of the trimmed graphic TG may be the aspect ratio of the trimmed graphic TG, or may be the size of the trimming frame TF relative to the source graphic SG. When the trimmed graphic TG does not fulfill the reference value (Step S164), the main control unit 110 performs a warning, using a graphic or a sound, to the user through a display unit 160 or a speaker (not shown) (Step S164). After this, the main control unit 110 may display, on the display unit 160, a graphic wherein the trimming frame TF is overlaid on the source graphic SG, and instructions for correcting the trimming frame TF are received from the user through an input button unit 170 (Step S166) to print a corrected trimmed graphic TG (Step S170). Note that in this modified example, when the trimmed graphic TG fulfills the reference value (Step 164), the trimmed graphic TG is printed as is, but, conversely, corrections to the trimming frame TF may be received (Step S166) even when the trimmed graphic TG fulfills the reference value. Moreover, instead of receiving corrections to the trimming frame TF (Step S166) when the trimmed graphic TG does not fulfill the reference value (Step S164), the main control unit 110 of the printing device 10 may perform a correction through reconciling the trimming frame TF to the reference value.

### B. Second Example of Embodiment

(Specifying the Trimming Region through Filling in)

The structure and operation of the printing device 10 in the second example of embodiment are the same as the structure and operations of the printing device 10 in the first example of embodiment, except for the point wherein the trimming region is specified through filling in, instead of through cut lines.

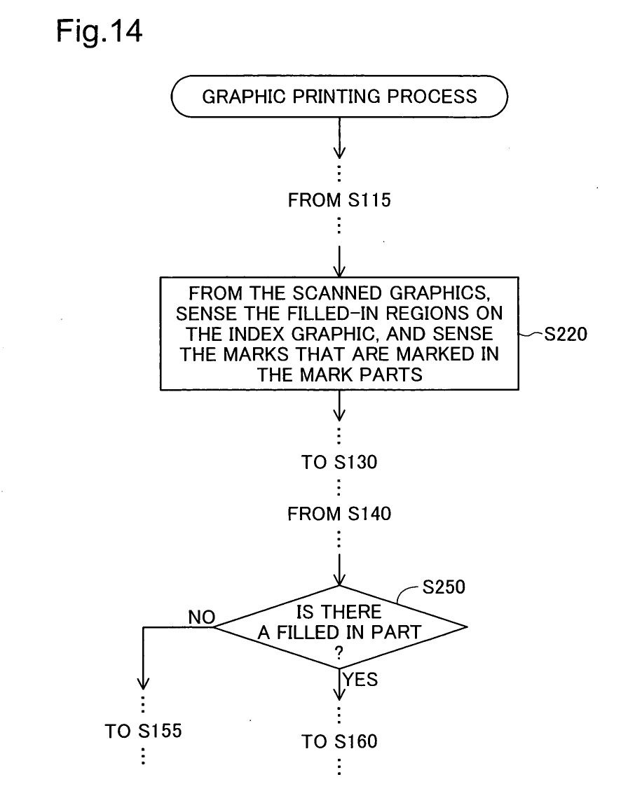

FIG. 14 is a flow chart illustrating the graphic printing process that is performed by the main control unit 110 of the printing device 10 in a second example of embodiment. The main control unit 110 of the printing device 10 scans an order sheet 910, wherein information for printing the graphic has been marked by the user (Step S115) after the order sheet 910, shown in FIG. 4, has been printed (Step S110) in the same manner as in the first example of embodiment.

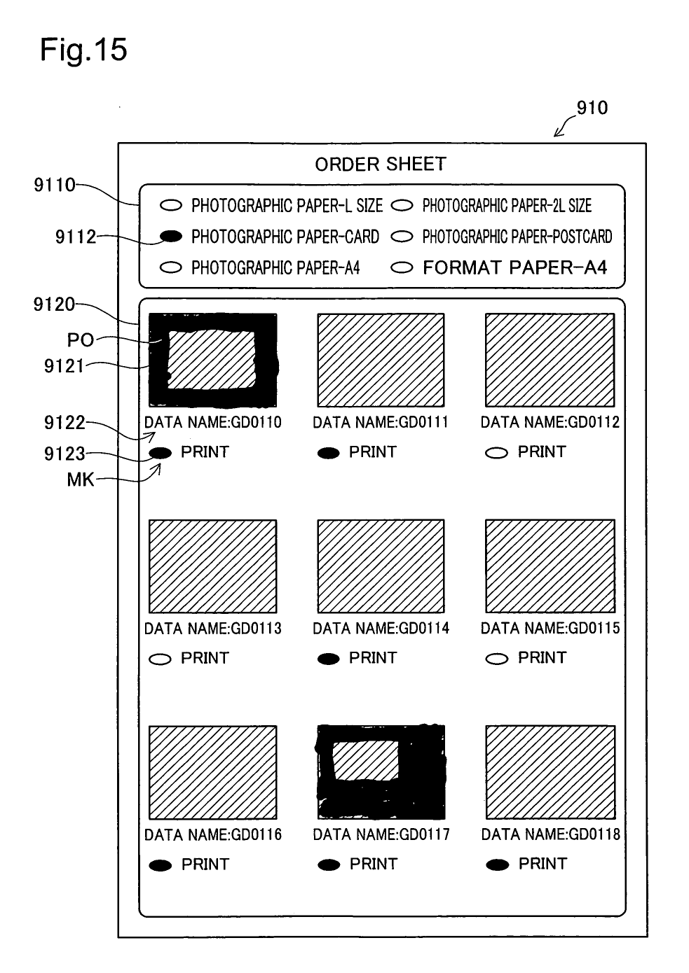

FIG. 15 is an explanatory diagram illustrating one example of the order sheet 910 from FIG. 4, wherein information for printing the graphic has been marked by the user in a second example of embodiment. The order sheet 910 in FIG. 15 has, as information marked by the user for printing the graphic, a mark MK wherein the inside of one of the plurality of mark parts 9112 of the printing paper specifying areas 9110 has been filled in, a mark MK wherein the insides of several of the plurality of mark parts 9123 of the printing status specifying areas 9120 have been filled in, and filled-in areas PO wherein several of the plurality of index graphics 9121 of the printing status specifying areas 9120 have been filled in.

In the example shown in FIG. 15, a mark MK is marked in the mark part 9112 corresponding to “PHOTOGRAPHIC PAPER—CARD” in the printing paper specifying areas 9110, marks MK are marked in the mark parts 9123 corresponding to the graphic data identified as the data names “GD0110,” “GD0111,” “GD0114,” “GD0116,” “GD0117,” and “GD0118” in the printing status specifying areas 9120, and the filled-in regions PO are marked on the index graphics 9121 corresponding to the graphic data, from among the graphic data selected above, identified as “GD0110” and “GD0117.”

Returning to the explanation of FIG. 14, after the order sheet 910 shown in FIG. 15 has been scanned (Step S115), the main control unit 110 senses, from the scanned graphic obtained from the scanner unit 130, the mark MK that is marked in the mark part 9112 of the printing paper specifying areas 9110, the marks MK marked in the mark parts 9123 of the printing status specifying areas 9120, and the filled-in regions PO marked in the index graphics 9121 in the printing status specifying areas 9120 (Step S220). Note that the sensing of the marks MK and the filled-in regions PO may be through the use of chromatic difference values Vcd between the printed index graphic IGp and the scanned index graphic IGs, or may use the extraction results Vex for a specific color.

After the marks MK and the filled-in region PO have been sensed from the scanned graphic (Step S220), then the main control unit 110 of the printing device 10 performs preparations for printing the first graphic in the sequence shown on the order sheet 910 (Step S130), after which the main control unit 110 of the printing device 10 determines whether or not the prepared graphic will be printed (Step S140). When it is determined that the prepared graphic will be printed (Step S140), the main control unit 110 determines whether or not a filled-in region PO has been sensed from on the index graphic 9121 corresponding to the graphic that has been prepared (Step S250). When it has been determined that a filled-in region PO has been sensed from on the index graphic 9121 (Step S250), the main control unit 110 specifies a cut portion CP (Step 160), and prints the trimmed graphic TG (Step S170).

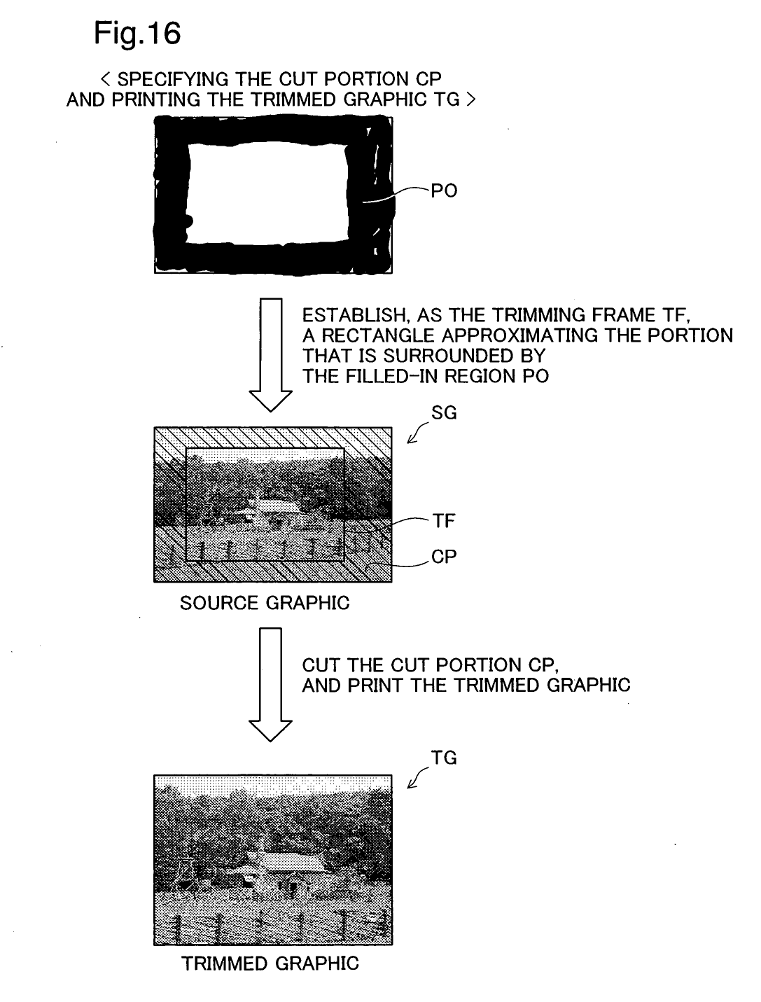

FIG. 16 is an explanatory diagram illustrating the state wherein a cut portion CP has been specified in the second example of embodiment, and the state wherein a trimmed graphic TG is printed in the second example of embodiment. In the second example of embodiment, the main control unit 110 of the printing device 10 sets a rectangle that approximates the portion surrounded by the filled-in region PO that has been specified, as the trimming frame TF, and then specifies, as the cut portion CP, the outside of the trimming frame TF (Step S160). After this, the main control unit 110 prints the trimmed graphic TG, wherein the cut portion CP has been cut from the source graphic SG, to the specified printing paper, at a size that matches that of the printing paper specified in the printing paper specifying area 9110 (Step S170).

Note that in the present example of embodiment, the trimming frame TF is set as a rectangle that approximates the portion encompassed by the filled-in region PO with an aspect ratio that has been set in advance; however, in another example of embodiment, a rectangle that approximates the portion that is encompassed by the filled-in area PO need not have an aspect ratio that is set in advance, but rather an area on the source graphic SG that is indicated by the trimming frame TF may be enlarged or reduced so as to have the aspect ratio that was set in advance.

The graphic printing technology of the second example of embodiment as described above, makes it possible to use the order sheet 910 to receive requirements from the user regarding the trimming process for the graphic to be printed. Moreover, the user is able to specify intuitively the cut portion CP, to be cut from the source graphic, using the filled-in region PO. Consequently, the graphic printing technology of the second example of embodiment is able to increase the convenience of printing a graphic using an order sheet.

### C. Third Example of Embodiment

(Specifying a Trimming Region Using Grid Lines)

The structure and operation of the printing device 10 in the third example of embodiment is the same as the structure and operation of the printing device 10 in the first example of embodiment with the exception of specifying the trimming region using grid lines instead of cut lines.

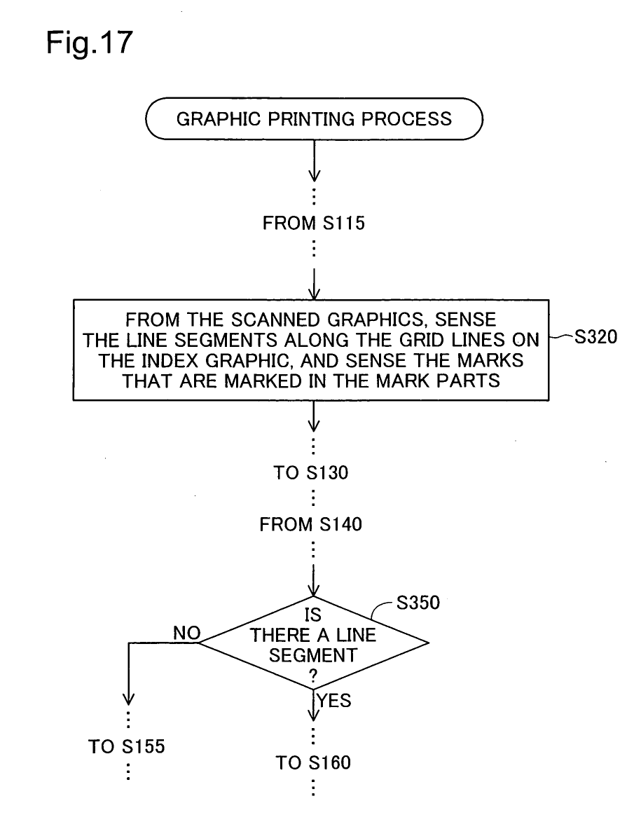

FIG. 17 is a flow chart illustrating the graphic printing process performed by the main control unit 110 of the printing device 10 in the third example of embodiment. After reading out the graphic data in the same manner as in the first example of embodiment (Step S105), the main control unit 110 of the printing device 10 prints an order sheet that is different from that of the first example of embodiment (Step S110).

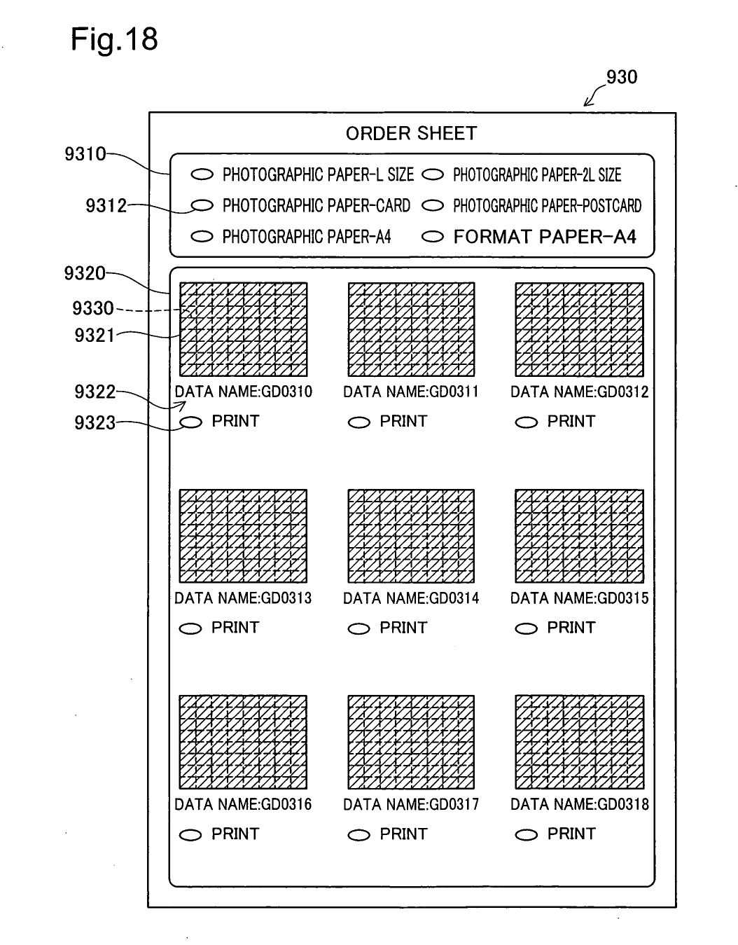

FIG. 18 is an explanatory diagram illustrating an example of an order sheet 930 that is printed by the printing device 10 in the third example of embodiment. The order sheet 930 in FIG. 18 is provided with a printing paper specifying area 9310 having mark parts 9312, and a printing status specifying area 9320 having index graphics 9321, data names 9322, and mark parts 9323, in the same manner as in the order sheet 910 of FIG. 4 in the first example of embodiment; however, there is a difference in that grid lines 9330 are added onto the index graphics 9321. In the present example of embodiment, the grid lines 9330 are an equal number of dotted lines in both the horizontal direction and the vertical direction on the index graphics 9321, dispose at equal intervals, and in the example in FIG. 18, the grid lines comprise seven dotted lines, disposed at equal intervals, in both the horizontal direction and the vertical direction.

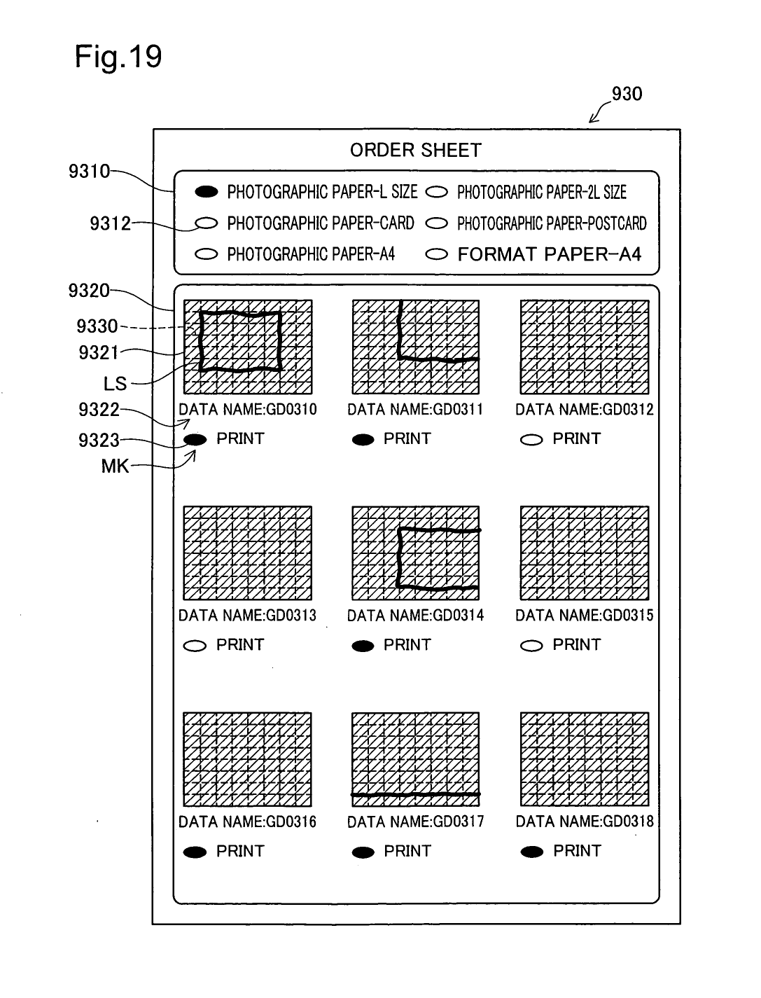

FIG. 19 is an explanatory diagram illustrating an example of the order sheet 930 of FIG. 18, wherein the user has marked information for printing graphics in the third example of embodiment. The order sheet 930 in FIG. 19 has, as information marked by the user for printing the graphics, marks MK wherein the inside of one of the plurality of the mark parts 9312 of the printing paper specifying area 9310 has been filled in, marks MK wherein the insides of several of the plurality of the mark parts 9323 of the printing status specifying area 9320 have been filled in, and line segments LS, written along the grid lines 9330 on several of the plurality of index graphics 9321 of the printing status specifying area 9320.

In the example shown in FIG. 19, a mark MK is marked in the mark part 9312 corresponding to “PHOTOGRAPHIC PAPER—L SIZE” in the printing paper specifying area 9310, marks MK are marked in the mark parts 9323 corresponding to the graphic data identified by the data names “GD0310,” “GD0311,” “GD0314,” “GD0316,” “GD0317,” and “GD0318,” and line segments LS are marked on the index graphics 9321 corresponding to those graphic data identified as “GD0310,” “GD0311,” “GD0314,” and “GD0317.”

In the example shown in FIG. 19, the line segments LS corresponding to the data name “GD0310” are four line segments encompassing a “5×5” rectangle that is partitioned in the center of the index graphic 9321, the line segments LS corresponding to the data name “GD0311” are two line segments surrounding a “5×5” rectangle including the corner part of the index graphic 9321, the line segments LS corresponding to the data name “GD0314” are three line segments encompassing a “5×5” rectangle including a portion of one edge of the index graphic 9321, and the line segments LS corresponding to the data name “GD0317” is a single line segment that cuts the index graphic 9321 into two parts.

Returning to the explanation of FIG. 17, after the printing of the order sheet 930 shown in FIG. 18 (Step S110), and the order sheet 930 shown in FIG. 19 has been scanned (Step S115), then the main control unit 110 of the printing device 10 senses, from the scanned graphic acquired from the scanner unit 130, the mark MK marked in the mark part 9312 of the printing paper specifying area 9310, the marks MK marked in the mark parts 9323 of the printing status specifying area 9320, and the line segments LS marked on the index graphics 9321 of the printing status specifying area 9320 (Step S320). Note that the sensing of the marks MK and the line segments LS may use chromatic difference values Vcd between the printed index graphic IGp and the scanned index graphic IGs, or may use the extraction results Vex for a specific color.

After the marks MK and the line segments LS have been sensed from the scanned graphics (Step S320), the main control unit 110 of the printing device 10 performs preparations for printing the first graphic in the sequence shown on the order sheet 930 (Step S130), and then determines whether or not the prepared graphic is to be printed (Step S140). When it is determined that the prepared graphic is to be printed (Step S140), then the main control unit 110 determines whether or not line segments LS have been sensed from on the index graphic 9321 corresponding to the graphic that has been prepared (Step S350). When it has been determined that a line segment LS has been sensed from on the index graphic 9321 (Step S350), the main control unit 110 specifies the cut portion CP (Step S160) and prints the trimmed graphic TG (Step S170).

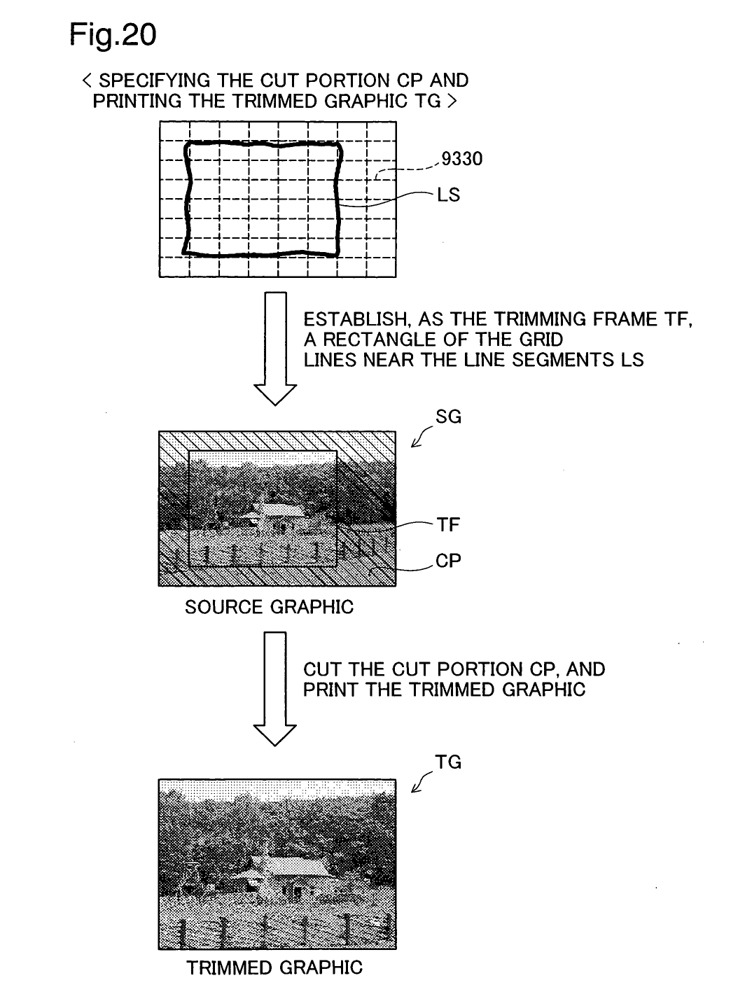

FIG. 20 is an explanatory diagram illustrating the state wherein a cut portion CP has been specified in the third example of embodiment, and the state wherein a trimmed graphic TG is printed. In the third example of embodiment, the main control unit 110 of the printing device 10 establishes, as the trimming frame TF, a rectangle that is demarcated by the grid lines 9330 that approximate the line segments LS that have been specified, and specifies, as the cut portion CP, the area that is outside of the trimming frame TF (Step S160). After this, the main control unit 110 prints onto the specified printing paper the trimmed graphic TG, wherein the cut portion CP has been cut from the source graphic SG, doing so with a size that matches that of the printing paper specified in the printing paper specifying area 9110 (Step S170).

For example, in the case of the order sheet 930 shown in FIG. 19, a “5×5” rectangle that is partitioned in the middle of the index graphic 9321 is established as the trimming frame TF for the data name “GD0310,” a “5×5” rectangle including one corner of the index graphic 9321 is established as the trimming frame TF for the data name “GD0311,” a “5×5” rectangle that includes a portion of one side of the index graphic 9321 is established as the trimming frame TF for the data name “GD0314,” and the rectangle with the larger surface area of the two rectangles formed by the partitioning by the line segment LS is established as the trimming frame TF for the data name “GD0317.”

The graphic printing technology in the third example of embodiment described above makes it possible for the printing device 10 to use the order sheet 930 to receive requirements from the user regarding the trimming process for the graphic to be printed. Moreover, the user is able to specify precisely, using line segments LS along the grid lines 9330, the cut portion CP to be removed from the source graphic SG. Moreover, the aspect ratios of each of the rectangles encompassed by the grid lines 9330 are the same as the aspect ratio of the trimmed graphic TG to be printed, and so by having the number of rectangles in the horizontal direction be the same as the number of rectangles in the vertical direction, it is possible to maintain an appropriate value for the aspect ratio of the trimmed graphic TG to be printed. Consequently, the graphic printing technology in the third example of technology makes it possible to improve the convenience of the printing of graphics using an order sheet.

### D. Fourth Example of Embodiment

(Specifying the Trimming Region Using Rulers)

The structure and operation of the printing device 10 according to the fourth example of embodiment is the same as the structure and operation of the printing device 10 in the first example of embodiment, with the exception that the trimming region is specified using rulers instead of cut lines.

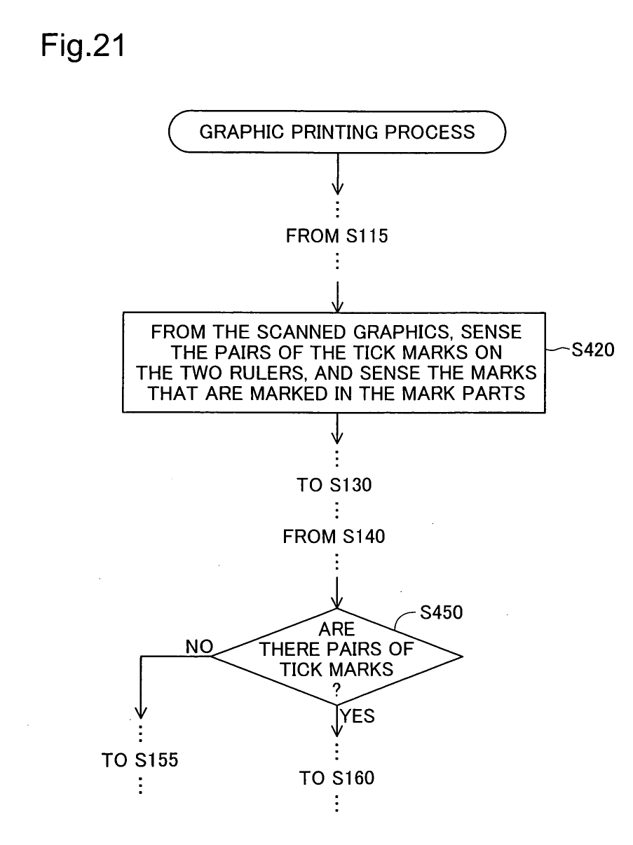

FIG. 21 is a flow chart illustrating a graphic printing process performed by the main control unit 110 of the printing device 10 in a fourth example of embodiment. The main control unit 110 of the printing device 10 performs the printing of an order sheet that is different from that in the first example of embodiment (Step S110) after reading out graphic data in the same manner as in the first example of embodiment (Step S105).

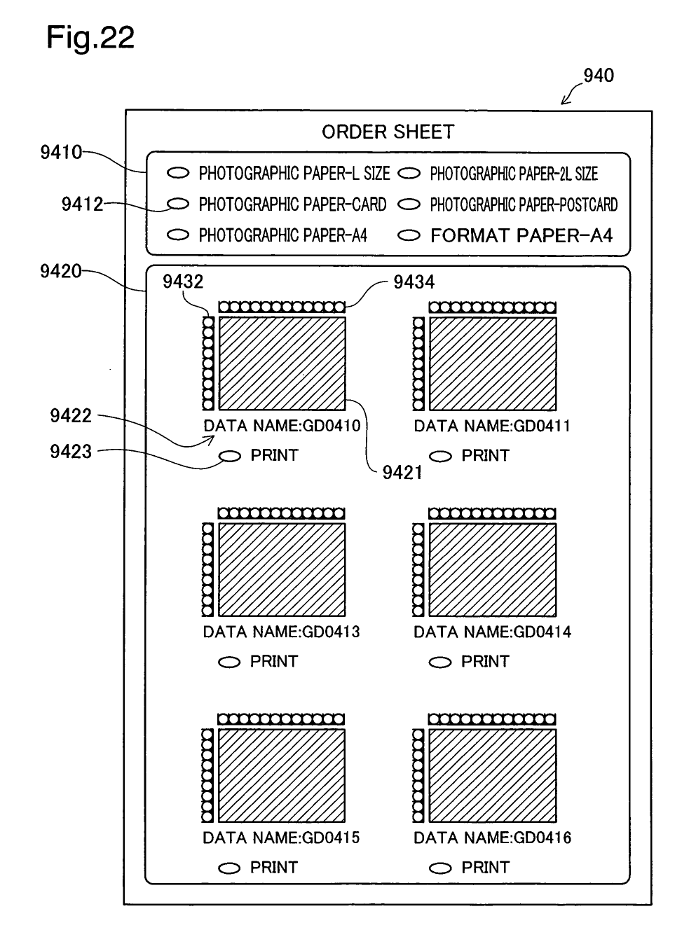

FIG. 22 is an explanatory diagram illustrating an example of an order sheet 940 printed by the printing device 10 according to a fourth example of embodiment. The order sheet 940 in FIG. 22 is provided with a printing paper specifying area 9410 having mark parts 9412, and a printing status specifying area 9420 having index graphics 9421, data names 9422, and mark parts 9423 in the same manner as in the order sheet 910 of FIG. 4 in the first example of embodiment. However, there is a difference in that there are vertical rulers 9432 and horizontal rulers 9434 added in the index graphics 9421. In the present example of embodiment, the vertical rulers 9432 and the horizontal rulers 9434 are each divided into equal intervals, and have a circular tick mark, the inside of which being white, for each interval.

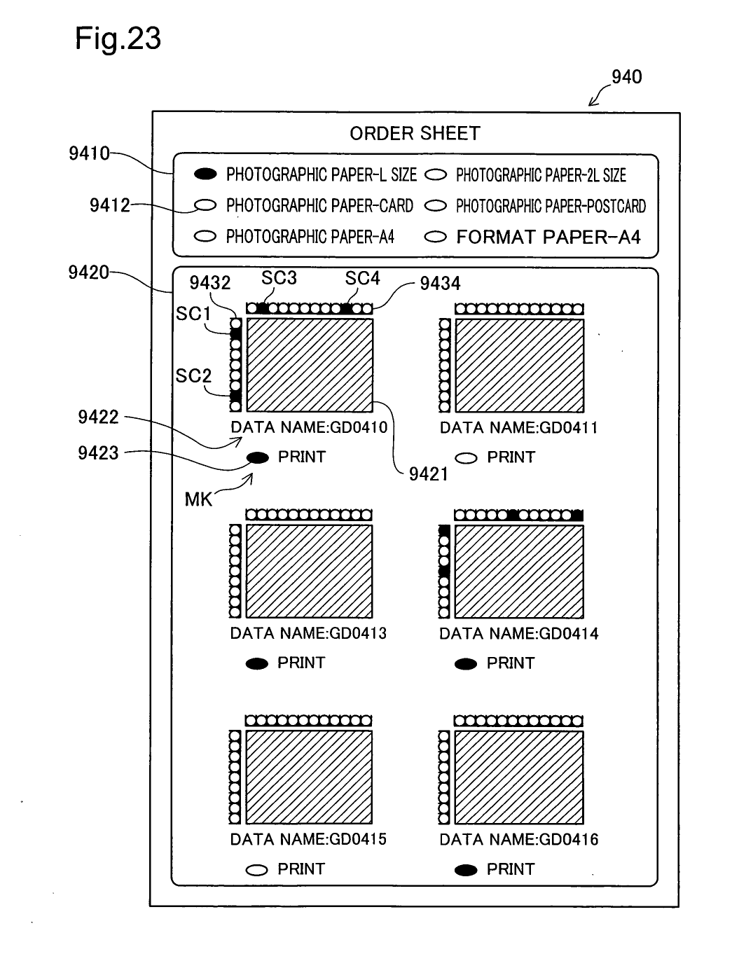

FIG. 23 is an explanatory diagram illustrating one example of an order sheet 940 of FIG. 22 wherein information for printing the graphic has been marked by the user, according to the forth example of embodiment. The order sheet of FIG. 23 has, as information marked by the user for printing the graphics, a mark MK wherein one of the plurality of mark parts 9412 of the printing paper specifying area 9410 has been filled in, marks MK wherein the insides of several of the plurality of mark parts 9423 of the printing status specifying area 9420 have been filled in, and tick marks SC1, SC2, SC3, and SC4 wherein the vertical rulers 9432 and the horizontal rulers 9434 for several of the plurality of index graphics 9421 of the printing status specifying area 9420 have been filled in. In the present example of embodiment, one set of tick marks SC1 and SC2 have been filled in for the vertical ruler 9432 for one of the index graphics 9421, and one set of tick marks SC3 and SC4 have been filled in the horizontal ruler 9434, so, in total, there are two pairs of tick marks SC1 and SC2, and tick marks SC3 and SC4 for one index graphic 9421.

In the example shown in FIG. 23, the mark MK is marked in the mark part 9412 corresponding to the “PHOTOGRAPHIC PAPER—L SIZE” in the printing paper specifying area 9410, and the marks MK are filled in for the mark parts 9423 corresponding to the graphic data identified with the data names “GD0410,” “GD0413,” “GD0414,” and “GD0416” in the printing status specifying area 9420, and the respective pairs of tick marks SC1 and SC2 and tick marks SC3 and SC4 are marked in the index graphics 9321 corresponding to those graphics data identified as “GD0410” and “GD0414.”

Returning the explanation of FIG. 21, after the order sheet 940 shown in FIG. 22 has been printed (Step S110), and the order sheet 940 shown in FIG. 23 has been scanned (Step S115), the main control unit 110 of the printing device 10 senses, from the scanned graphics obtained from the scanner unit 130, the mark MK marked in the mark part 9412 of the printing paper specifying area 9410, the marks MK marked in the mark parts 9423 of the printing status specifying area 9420, and the pairs of tick marks SC1 and SC2 and tick marks SC3 and SC3 marked in the index graphics 9321 of the printing status specifying area 9420 (Step S420).

After sensing, from the scanned graphics, the marks MK and the pairs of tick marks SC1 and SC2, and tick marks SC3 and SC4 (Step S420), the main control unit 110 of the printing device 10 performs preparations for printing the first graphic in the sequence shown in the order sheet 940 (Step S130), and then determines whether or not the prepared graphic is to be printed (Step S140). When it is determined that the prepared graphic is to be printed (Step S140), then the main control unit 110 determines whether or not the two pairs of tick marks SC1 and SC2 and tick marks SC3 and SC4, marked in the index graphic 9421 corresponding to the prepared graphic have been sensed (Step S450). If it is determined that the two pairs of tick marks SC1 and SC2, and tick marks SC3 and SC4 have been sensed from on the index graphic 9421 (Step S450), then the main control unit 110 specifies the cut portion CP (Step S160) and performs the printing of the trimmed graphic TG (Step S170).

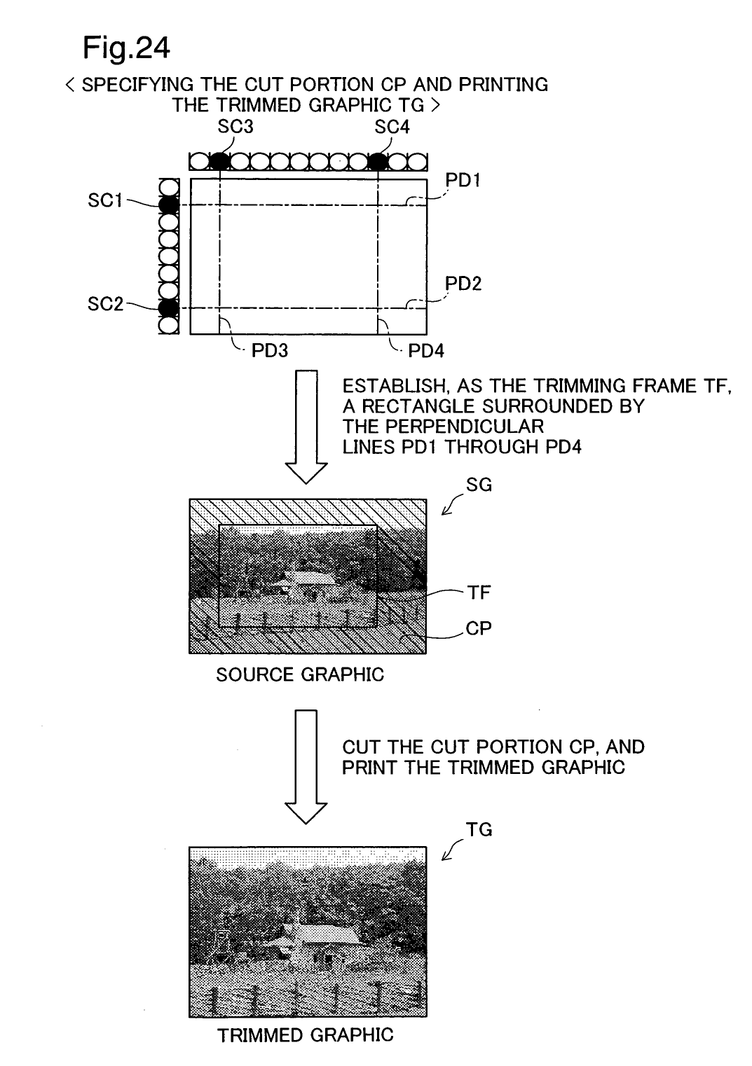

FIG. 24 is an explanatory diagram illustrating the state wherein a cut portion CP has been specified in the fourth example of embodiment, and a trimmed graphic TG is printed in the fourth example of embodiment. In the fourth example of embodiment, the main control unit 110 of the printing device 10 establishes, as a trimming frame, the rectangle encompassed by the perpendicular lines PD1 and PD2, and perpendicular lines PD3 and PD4, from the middles of the respective specified sets of tick marks SC1 and SC2 and tick marks SC3 and SC4, and specifies as the cut portion CP the area that is outside of this trimming frame TF (Step S160). Following this, the main control unit 110 prints, to the specified printing paper, the trimmed graphic TG wherein the cut portion CP has been cut from the source graphic SG, doing so with a size that matches that of the printing paper that has been specified by the printing paper specifying area 9110 (Step S170).

The graphic printing technology in the fourth example of embodiment, described above, makes it possible for the printing device 10 to use the order sheet 940 to receive requirements from the user regarding the trimming process for the graphics to be printed. Moreover, the user is able to specify with precision the portion of the source graphic SG that is to remain as the trimmed graphic TG. Consequently, the graphic printing technology in the fourth example of embodiment makes it possible to increase the convenience of printing graphics using an order sheet.

### E. Fifth Example of Embodiment

(Specifying the Trimming Region Using Rulers)

The structure an operation of the printing device 10 according to the fifth example of embodiment is the same as the structure and operation of the printing device in the first example of embodiment, except for specifying the trimming region using rulers instead of cut lines.

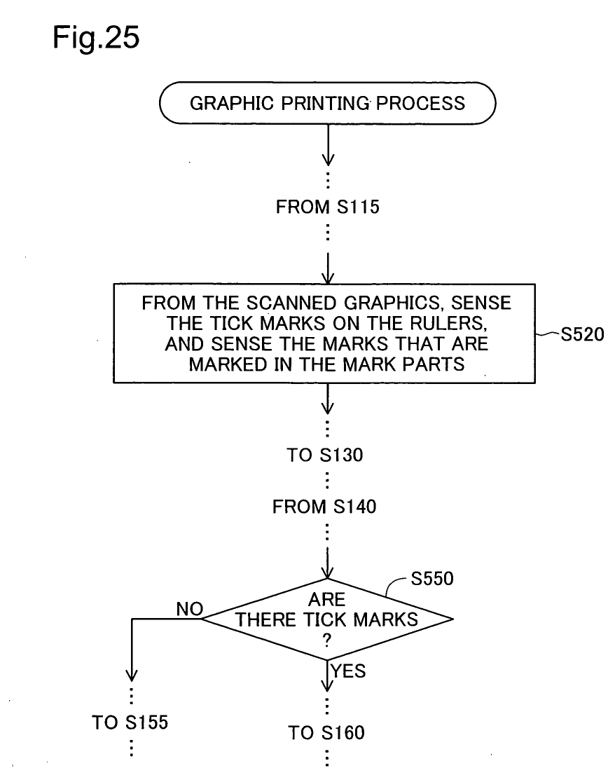

FIG. 25 is a flow chart illustrating the graphic printing process that is performed by the main control unit 110 of the printing device 10 according to the fifth example of embodiment. The main control unit 110 of the printing device 10 prints the order sheet 940 shown in FIG. 22 (Step S110) and then scans the order sheet 940 wherein the user has marked information for printing the graphics (Step S115) in the same manner as in the fourth example of embodiment.

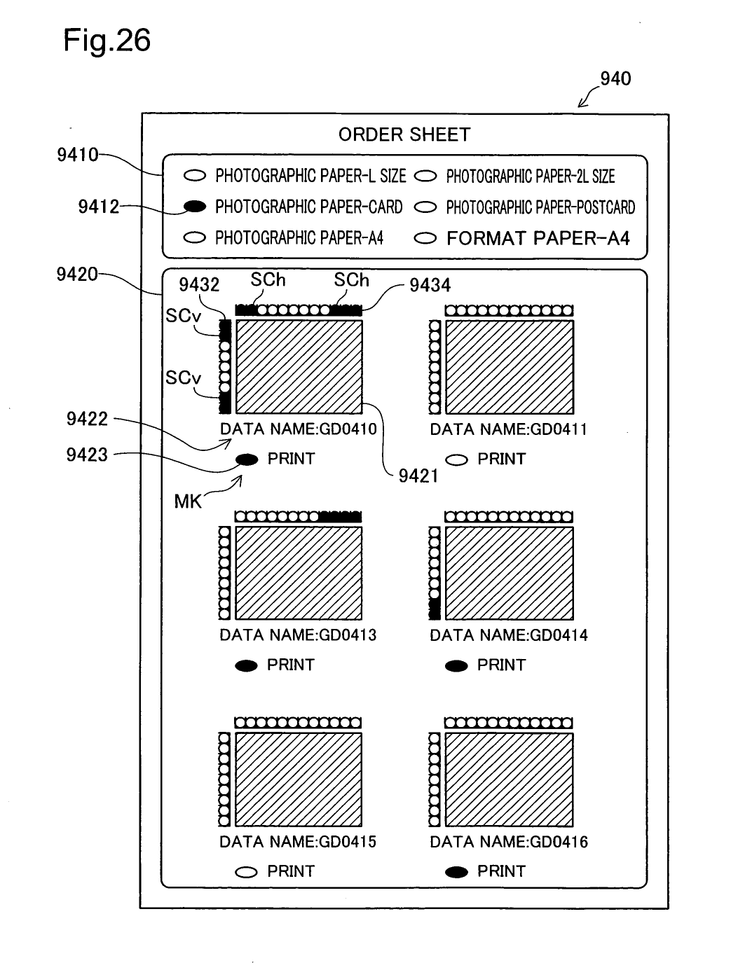

FIG. 26 is an explanatory diagram illustrating one example of an order sheet 940 of FIG. 22, wherein information for printing the graphics has been marked by the user, according to a fifth example of embodiment. In the order sheet in FIG. 26, there is, as information marked by the user for printing the graphics, a mark MK wherein the inside of one of the plurality of mark parts 9412 of the printing paper specifying area 9410 has been filled in, marks MK wherein the insides of several of the plurality of mark parts 9423 of the printing status specifying area 9420 have been filled in, a tick mark SCv wherein the vertical rulers 9432 for several of the plurality of index graphics 9421 in the printing status specifying area 9420 have been filled in, and tick marks SCh wherein the horizontal rulers 9434 of several of the plurality of index graphics 9421 of the printing status specifying area 9420 have been filled in.

In the example illustrated in FIG. 26, a mark MK is marked in the mark part 9412 corresponding to “PHOTOGRAPHIC PAPER—CARD” in the printing paper specifying area 9410, marks MK are marked in the mark parts 9423 corresponding to the graphic data identified by the data names “GD0410,” “GD0413,” “GD0414,” and “GD0416,” the tick marks SCv and SCh are marked for the graphic data with the data name “GD0410,” the tick mark SCh is marked for the graphic data with the data name “GD0413,” and the tick mark SCv is marked for the graphic data with the data name “GD0414.”

Returning to the explanation of FIG. 25, after the order sheet 940 shown in FIG. 26 has been scanned (Step S115), the main control unit 110 senses, from the scanned graphics that have been acquired from the scanning unit 130, the mark MK that is marked in the mark part 9412 of the printing paper specifying area 9410, the marks MK that are marked in the mark parts 9423 of the printing status specifying area 9420, and the tick marks SCv and SCh that are marked in the index graphics 9121 in the printing status specifying area 9420 (Step S520).

After the marks MK and tick marks SCv and SCh have been sensed from the scanned graphics (Step S520), the main control unit 110 of the printing device 10 performs preparations for printing the first graphic in the sequence shown in the order sheet 940 (Step S130), and then determines whether or not the prepared graphic is to be printed (Step S140). When it is determined that the prepared graphic is to be printed (Step S140), then the main control unit 110 determines whether or not the tick mark SCv and/or the tick mark SCh, marked in the index graphic 9421 corresponding to the graphic that has been prepared, has been sensed (Step S550). If it is determined that the tick mark SCv and/or the tick mark SCh has been sensed from on the index graphic 9421 (Step S550), then the main control unit 110 specifies the cut portion CP (Step S160) and prints the trimmed graphic TG (Step S170).

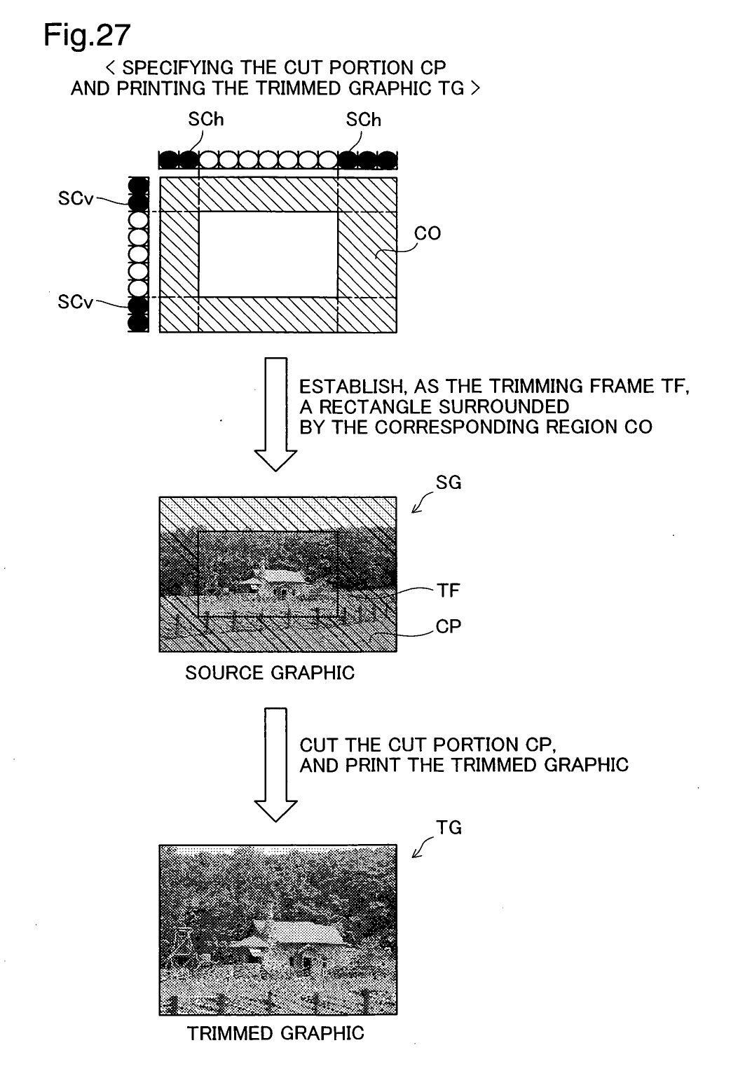

FIG. 27 is an explanatory diagram illustrating the state wherein a cut portion CP has been specified in the fifth example of embodiment, and the state wherein a trimmed graphic TG is printed in the fifth example of embodiment. In the fifth example of embodiment, the main control unit 110 of the printing device 10 establishes a rectangle that includes the corresponding region CO that combines the region in the horizontal direction of the index graphic 9421 indicated by the tick mark SCv and the region in the vertical direction of the index graphic 9421 indicated by the tick mark SCh, as the trimming frame TF, and specifies, as the cut portion CP, the area that is outside of the trimming frame TF (Step S160). After this, the main control unit 110 prints onto the specified printing paper the trimmed graphic TG wherein the cut portion CP has been cut from the source graphic SG, doing so with a size that matches that of the printing paper specified in the printing pager specifying area 9110 (Step S170).

Note that in the case of the order sheet 940 shown in FIG. 26, for example, a rectangle that excludes the region corresponding to the vertical direction of the index graphic 9241, shown by the tick mark SCh for the data name “GD0413” is established as the trimming frame TF, and for the data name “GD0414,” a rectangle excluding the corresponding region CO in the horizontal direction of the index graphic 9421 shown by the tick mark SCv is established as the trimming frame TF.

The graphic printing technology according to the fifth example of embodiment, described above, makes it possible for the printing device 10 to use an order sheet 940 to receive requirements from the user regarding the trimming process for the graphics to be printed. Moreover, the user is able to specify with accuracy the cut portion CP to be removed from the source graphic SG. Consequently, in the graphic printing technology in the fifth example of embodiment, it is possible to increase the convenience of printing of graphics using an order sheet.

### F. Sixth Example of Embodiment

(Specifying the Trimming Region Using Trimming Patterns)

The structure and operation of the printing device 10 according to a sixth example of embodiment is the same as the structure and operation of the printing device 10 in the first example of embodiment, except that the trimming region is specified using a trimming pattern instead of using cut lines.

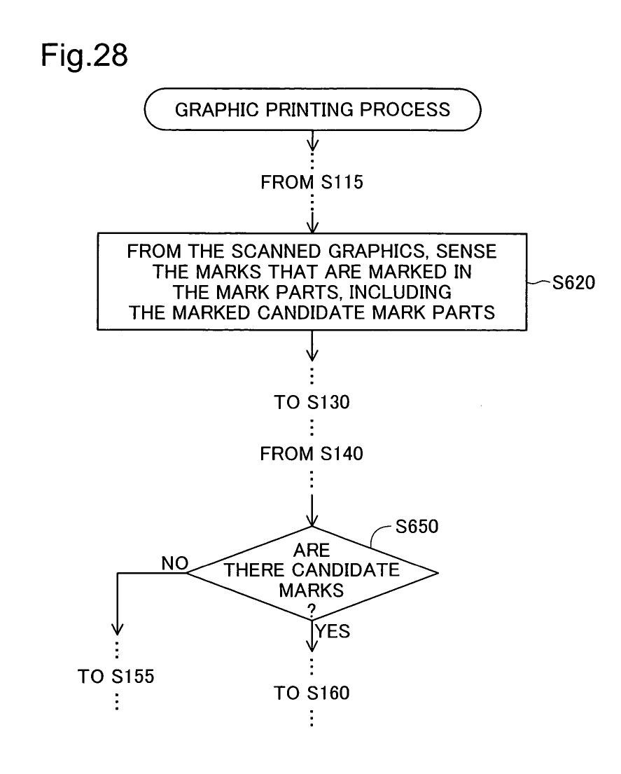

FIG. 28 is a flow chart illustrating the graphic printing process that is performed by the main control unit 110 of the printing device 10 in the sixth example of embodiment. The main control unit 110 of the printing device 10 reads out the graphic data in the same manner as in the first example of embodiment (Step S105) and then prints an order sheet that is different than that in the first example of embodiment (Step S110).

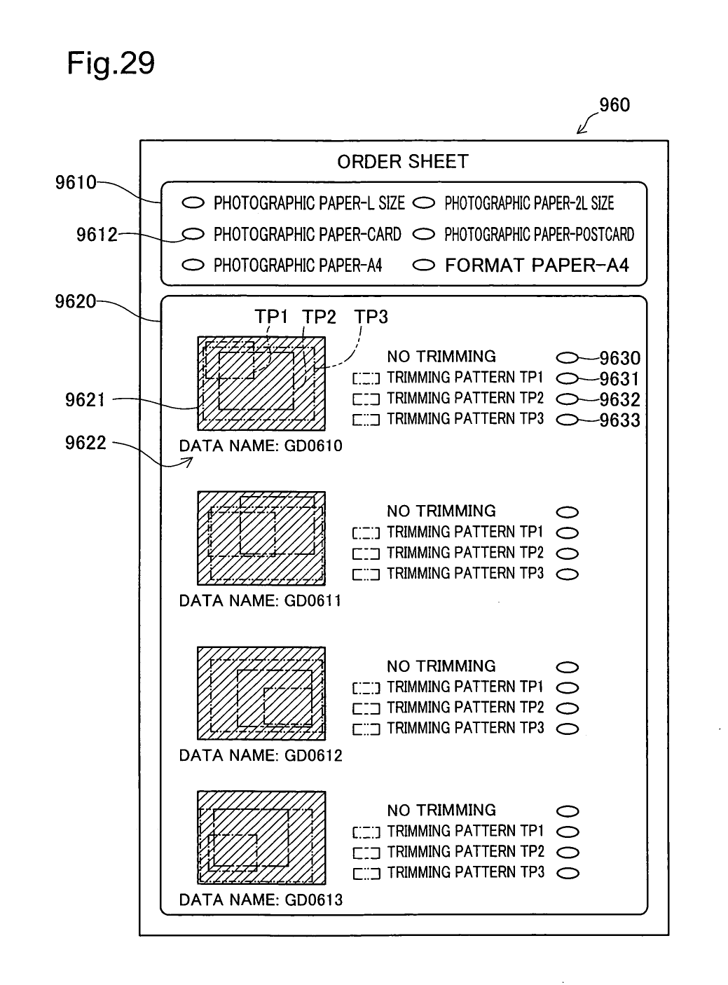

FIG. 29 is an explanatory diagram illustrating one example of an order sheet 960 that is printed by the printing device 10 according to the sixth example of embodiment. The order sheet 960 of FIG. 29 has a printing paper specifying area 9610 that is the same as the printing paper specifing area 9110 that is in the order sheet 910 of FIG. 4 in the first example of embodiment, and has a printing status specifying area 9620 that is a fill-in area that receives, from the user, marks for information for specifying the printing status regarding the various graphics based on the graphic data.

The printing status specifying area 9620 of the order sheet 960 has data names 9622 that are identifiers for identifying each of the graphic data that are read out, index graphics 9261 that display graphics based on each of the graphics data, mark parts 9630 wherein the user can fill in to provide instructions to print the graphics without trimming, a plurality of trimming patterns TP1, TP2, and TP3 that are rectangular shapes that are applied on the index graphics 9621, and candidate mark parts 9631, 9632 and 9633 that can be marked by the user to provide instructions for trimming the respective graphics with the respective trimming patterns TP1, TP2, and TP3 and then printing. In the present example of embodiment, the shapes of the trimming patterns TP1, TP2, and TP3 are determined for each graphic based on graphical analysis standards that are established in advance.

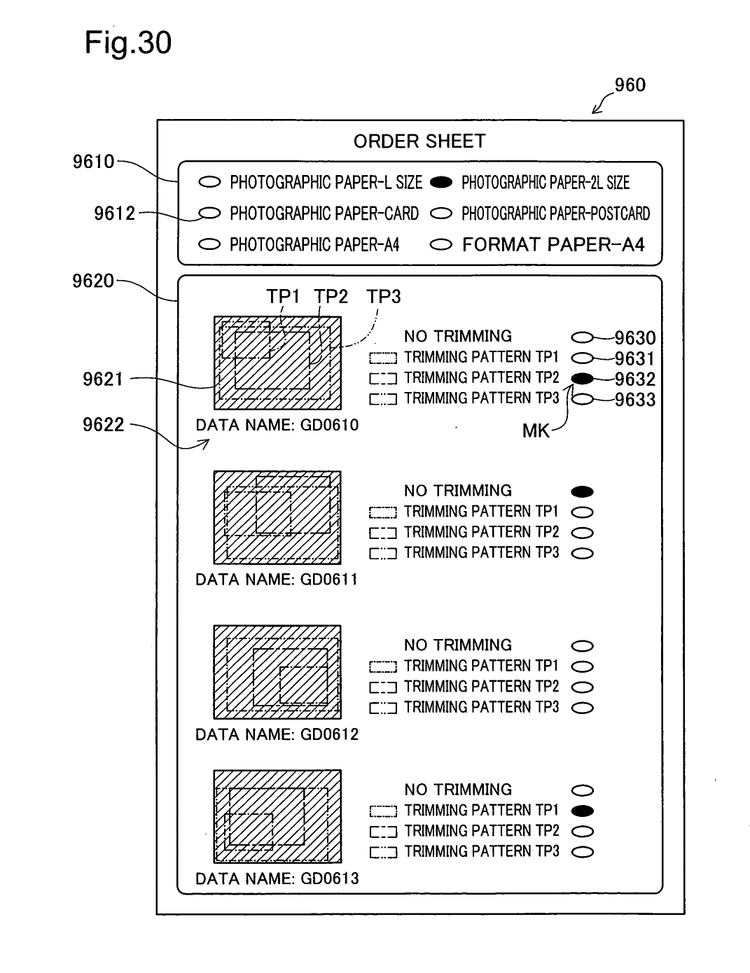

FIG. 30 is an explanatory diagram illustrating one example of an order sheet 960 of FIG. 29 wherein information for printing the graphics has been filled in by the user in accordance with the sixth example of embodiment. The order sheet 960 in FIG. 30 has, as information that is marked by the user for printing the graphic, a mark MK wherein the inside of one of the plurality of the mark parts 9612 of the printing paper specifying area 9610 has been filled in, and marks MK wherein the insides of the mark part 9630 and several of the candidate mark parts 9631, 9632 and 9633 of the printing status specifying area 9620 have been filled in.

In the example illustrated in FIG. 30, in the printing paper specifying area 9610, the mark MK of the mark part 9612 corresponding to “PHOTOGRAPHIC PAPER—2L SIZE” is marked, the mark MK for the candidate mark part 9632 corresponding to the trimming pattern TP2 is marked for the data name “GD0610,” the mark MK is marked in the mark part 9630 for the data name “GD0611,” no mark MK is marked for the data name “GD0612,” and a mark MK is marked for the candidate mark part 9631 corresponding to the trimming pattern TP1 for the data name “GD0613.”

Returning to the explanation of FIG. 28, after the printing of the order sheet 960 shown in FIG. 29 (Step S110) and the scanning of the order sheet 960 shown in FIG. 30 (Step S115) is performed, then the main control unit 110 of the printing device 10 senses, from the scanned graphics acquired from the scanner unit 130, the mark MK that is marked in the mark part 9612 of the printing paper specifying area 9610, and the marks MK that are marked in the mark part 9630 and the candidate mark parts 9631, 9632, and 9633 of the printing status specifying area 9320 (Step S620).

After the marks MK have been sensed from the scanned graphics (Step S620) then the main control unit 110 of the printing device 10 performs preparations for printing the graphic that is first in the sequence shown on the order sheet 960 (Step S130) after which the main control unit 110 determines whether or not the graphic that has been prepared is to be printed, or in other words, whether or not a mark MK has been sensed in the mark part 9630 or any of the candidate mark parts 9631, 9632, or 9633 (Step S140). When it is determined that the graphic that has been prepared is to be printed (Step S140), then the main control unit 110 of the printing device 10 determines whether there is a mark MK in any of the candidate mark parts 9631, 9632, or 9633 (Step S650). When it has been determined which of the candidate mark parts 9631, 9632, or 9633 has been sensed as having a mark MK (Step S650), then the main control unit 110 specifies the cut portion C (Step S160) and perform the printing of the trimmed graphic TG (Step S170).

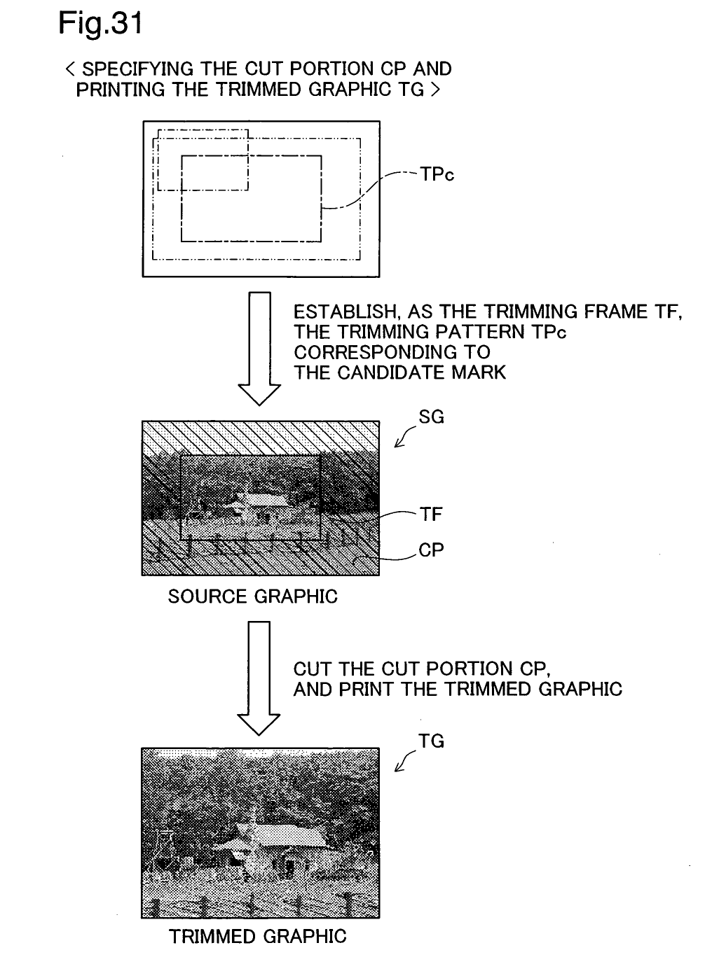

FIG. 31 is an explanatory diagram illustrating the state wherein a cut portion CP has been specified in the sixty example of embodiment, and the state wherein the trimmed graphic TG is printed in the sixth example of embodiment. In the sixth example of embodiment, the main control unit 110 of the printing device 10 establishes, as the trimming frame TF, the trimming pattern TPc corresponding to the candidate mark for which, of the plurality of trimming patterns TP1, TP2, and TP3, the mark MK has been marked, and defines, as the cut portion CP, the area outside of the trimming frame TF (Step S160). Following this, the main control unit 110 prints to the printing paper the trimmed graphic TG wherein the cut portion CP has been cut from the source graphic SG, doing so with a size that matches the printing paper specified by the printing paper specifying area 9110 (Step S170).

The graphic printing technology according to the sixth example of embodiment described above makes it possible for the printing device 10 to use an order sheet 960 to receive requirements from the user regarding the trimming process for the graphics to be printed. Moreover, by selecting one of the trimming patterns TP1, TP2, or TP3, the user is able to specify easily the portions on the graphic to remain as the trimmed graphic TG. Consequently, the graphic printing technology in the sixth example of embodiment is able to increase the convenience of printing of graphics using an order sheet.

### G. Seventh Example of Embodiment

(Specifying the Performance of Trimming)

The structure and operation of the printing device 10 according to the seventh example of embodiment is the same as the structure and operation of the printing device 10 according to the first example of embodiment, with the exception of receiving trimming adjustments from the user after receiving, from the user, a specification as to whether or not to perform trimming, doing so using the order sheet, instead of specifying the trimming region using cut lines.

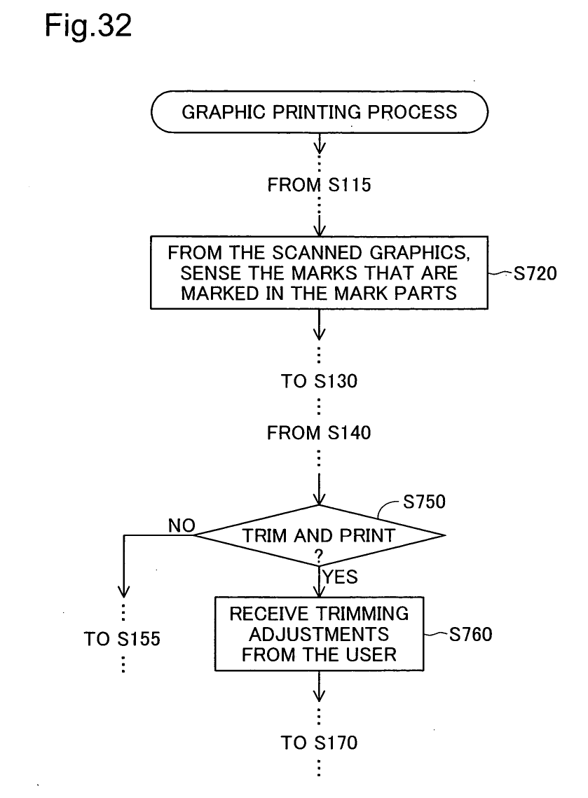

FIG. 32 is a flow chart illustrating the graphic printing process executed by the main control unit 110 of the printing device 10 according to the seventh example of embodiment. The main control unit 110 of the printing device 10 reads out the data in the same way as in the first example of embodiment (Step S105), and then prints an order sheet that is different from that in the first example of embodiment (Step 110).

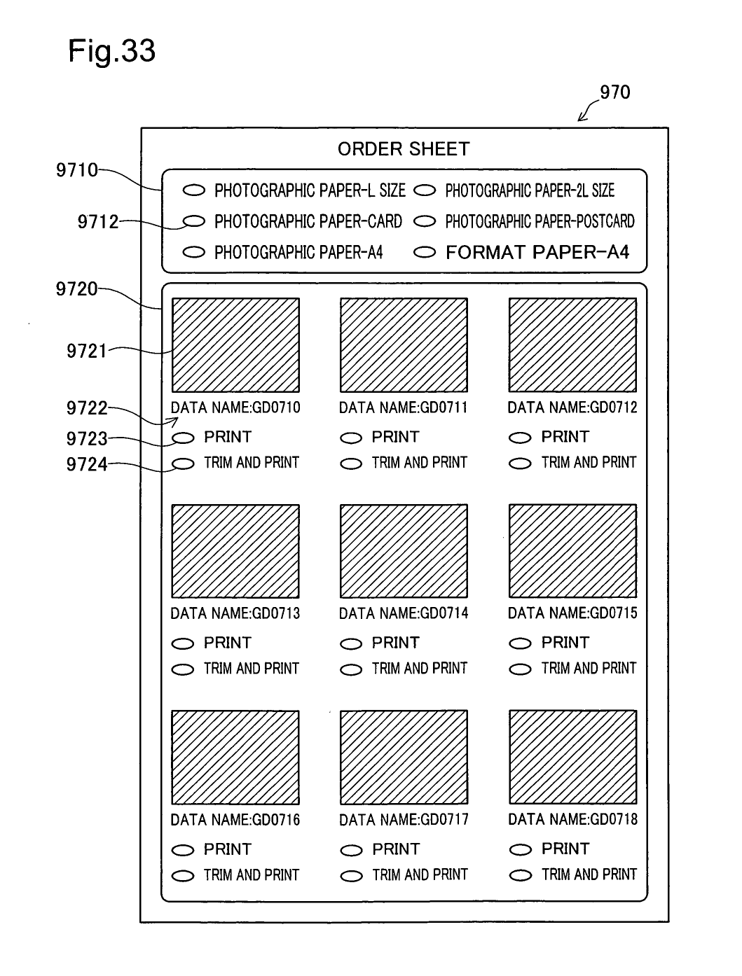

FIG. 33 is an explanatory diagrams illustrating one example of an order sheet 970 that is printed by the printing device 10 according to the seventh example of embodiment. The order sheet 970 in FIG. 33 has a printing paper specifying area 9710 that is the same as the printing paper specifying area 9110 in the order sheet 910 of FIG. 4 according to the first example of embodiment, and a printing status specifying area 9720 that is a fill-in area that can receive, from the user, marks for information for specifying the printing status for each of the individual graphics based on the graphic data. The printing status specifying area 9720 of the order sheet 970 has data names 9722 that are identifiers for identifying each of the individual graphic data that are read out, index graphics 9721 that show the graphics based on each of the graphic data, mark parts 9723 for receiving, from the user, marks that specify printing of the graphics without trimming, and mark parts 9724 for receiving, from the user, marks that specify printing of the graphics after trimming.

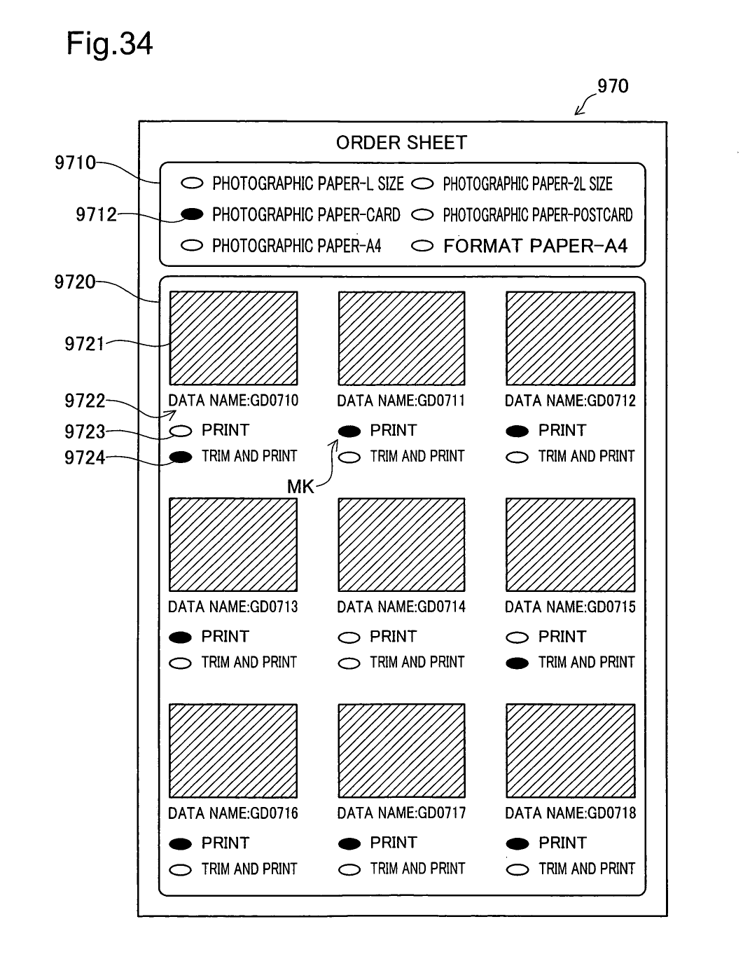

FIG. 34 is an explanatory diagram illustrating one example of an order sheet 970 of FIG. 33, wherein information for printing the graphics has been marked by the user in the seventh example of embodiment. The order sheet 970 of FIG. 34 has, as data that is marked by the user for printing graphics, a mark MK wherein the inside of one of the plurality of mark parts 9712 of the printing paper specifying area 9710 has been filled in, and marks MK wherein the insides of the mark parts 9723 and mark parts 9724 of the printing status specifying area 9270 have been filled in.

In the example shown in FIG. 34, the mark MK has been marked in the mark parts 9712 that corresponds to “PHOTOGRAPHIC PAPER—CARD” in the printing paper specifying area 9710, and, in the printing status specifying area 9720, marks the MK are marked for the mark parts 9724 for the data names “GD0710,” and “GD0715,” marks MK are marked for the mark parts 9723 for the data names “GD0711,” “GD0712,” “GD0713,” “GD0716,” “GD0717,” and “GD0718,” and no mark is marked for either the mark part 9723 or the mark part 9724 for the data name “GD0714.”

Returning to the explanation of FIG. 32, after the printing of the order sheet 970 shown in FIG. 33 (Step S110) and the scanning of the order sheet 970 shown in FIG. 34 (Step S115), the main control unit 110 of the printing device 10 senses, from the scanned graphics obtained from the scanner unit 130, the mark MK that is marked on the mark part 9712 of the printing paper specifying area 9710, and the marks MK that are marked into the mark parts 9723 and 9724 of the printing status specifying area 9720 (Step S720).

After sensing the marks MK from the scanned graphics (Step S720), the main control unit 110 of the printing device 10 performs preparations for printing the first graphic in the sequence shown in the order sheet 970 (Step S130), after which a decision is made as to whether or not to print the prepared graphics, or in other words, determines whether or not there is a mark MK for the mark part 9723 or the mark part 9724 (Step S140). When it is determined that the graphic it has been prepared is to be printed (Step S140), then it is determined whether or not a mark MK has been sensed in the mark part 9724 (Step S750). If it is determined that a mark MK has been sensed in the mark part 9724 (Step S750), then the main control unit 110 displays, on a display unit 160, a graphic wherein a trimming frame TF is superimposed on the source graphic SG, and receives, through an input but in unit 170, instructions from the user regarding adjusting the trimmed graphic TG (Step S760). Following this, the main control unit 110 performs the printing of the trimmed graphic TG that has been adjusted (Step S170).

The graphic printing technology according to the seventh example of embodiment, described above, makes it possible for the printing device 10 to use an order sheet 970 to receive requirements from the user regarding whether or not it is necessary to perform the trimming process for the graphics to be printed. Consequently, the graphic printing technology in the seventh example of embodiment makes it possible to increase the convenience of printing graphics using an order sheet.

### H. Eighth Example Embodiment

(Specifying Borderless Printing)

The structure and operation of the printing device 10 in an eighth example embodiment is the same as the structure and operation of the printing device 10 in the first example embodiment, except for the point wherein printing adjustments are received from the user after using an order sheet to receive, from the user, instructions for whether or not printing is necessary and for whether or not to perform borderless printing, instead of specifying the trimming region using cut lines.

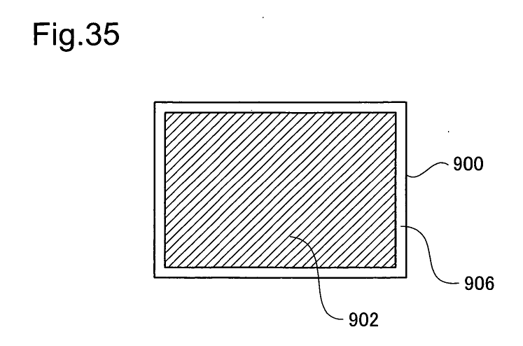

In the present example embodiment, “borderless printing” refers to a function wherein printing is performed so as to not create a white edge of the border (edge) of the printing medium 900. In the present example of embodiment, “borderless printing” is achieved through printing in the printed graphics slightly larger than the printing medium 900; however, in order to prevent the printed graphic from extending beyond the printing medium 900, this may be achieved through printing the printing graphic with the same size as that of the printing medium 900. FIG. 35 is an explanatory diagram illustrating one example of a printing medium 900 where one and graphic has been printed in a borderless state. For normal printing, wherein “borderless printing” is not required, or in other words, when “printing with a border,” a border 906 is formed on the edge of the printing medium 900, as shown in FIG. 35, and the graphic is printed in the printing region 902 that is surrounded by the border 906.

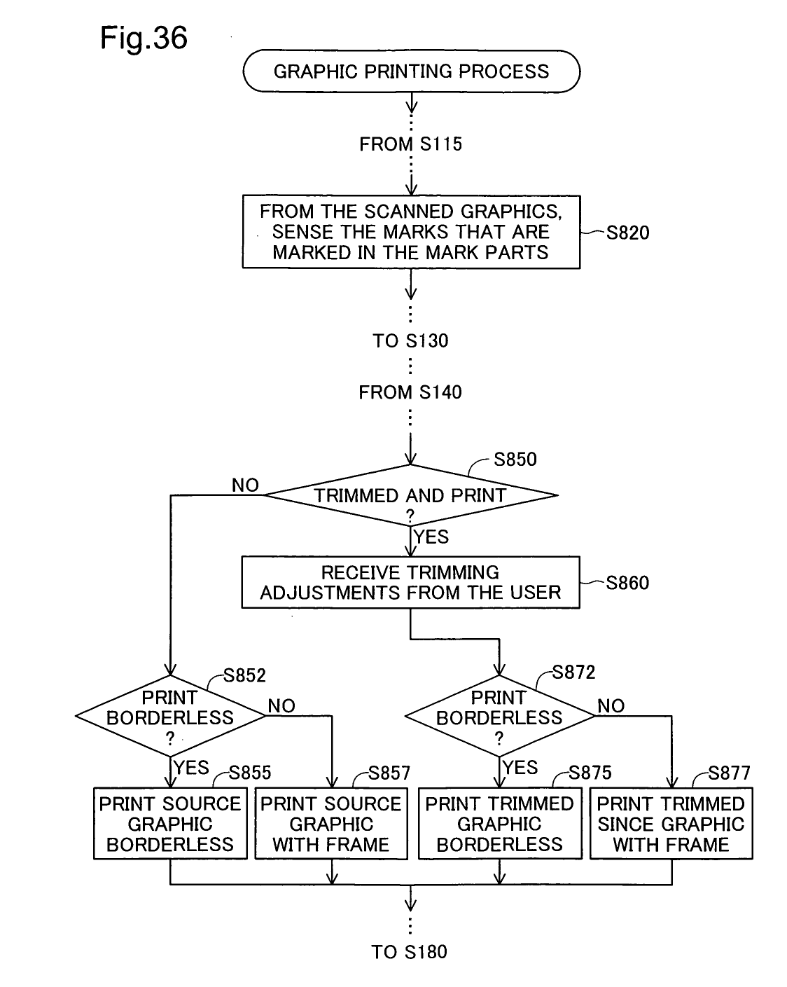

FIG. 36 is a flowchart illustrating the graphic printing process that is performed by the main control unit 110 of the printing device 10 according to the eighth example of embodiment. The main control unit 110 of the printing device 10 reads out the graphic data in the same manner as in the first example of embodiment (Step S105), and then prints an order sheet that is different and that in the first example of embodiment (Step S110).

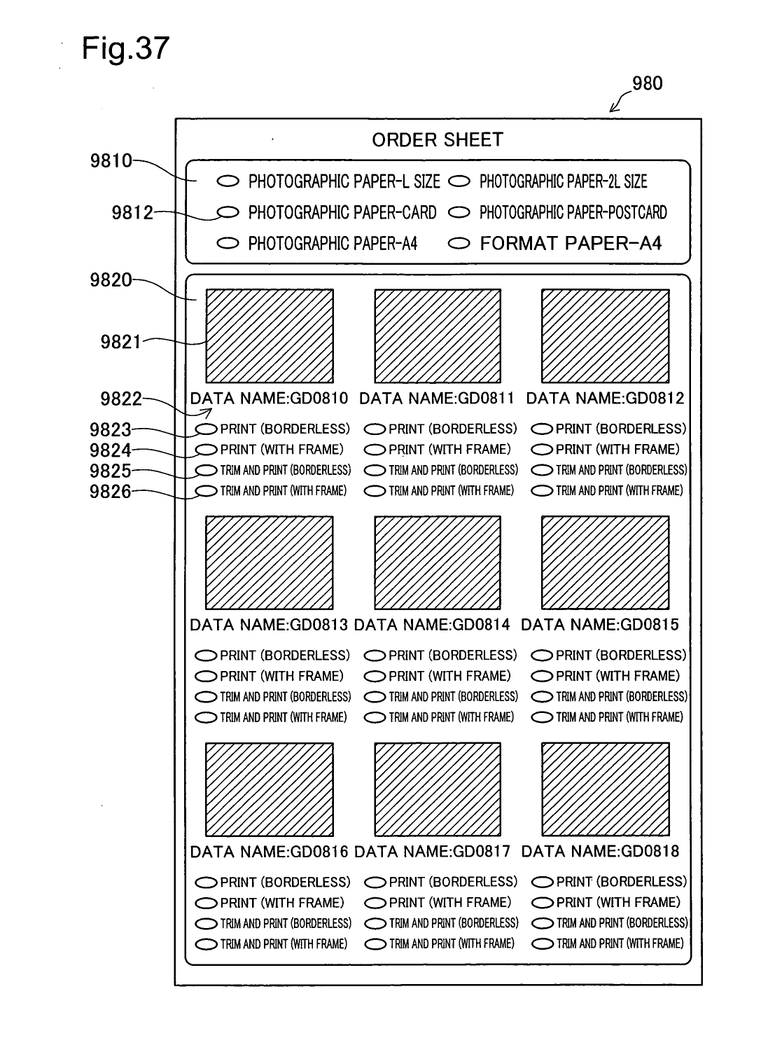

FIG. 37 is an explanatory diagram illustrating one example of an order sheet 980 that is printed by the printing device 10 according to the eighth example of embodiment. The order sheet 980 of FIG. 37 has a printing paper specifying area 9810 that is the same as the printing paper specifying area 9110 in the order sheet 910 of FIG. 4 in the first example of embodiment, and has a printing status specifying area 9820, which is a fill-in area that can receive, from the user, marks for information for specifying the printing status for each of the individual graphics based on the graphic data. The printing status specifying area 9820 in the order sheet 980 has data names 9822, which are identifiers for identifying each of the graphic data that have been read out, index graphics 9821 that show the graphics based on the graphics based on the individual graphics data, mark parts 9823 that receive marks from the user specifying that the graphics are to be printed “without trimming” and “without borders,” mark parts 9824 that receive marks from the user specifying that the graphics are to be printed “without trimming” and “with borders,” mark parts 9825 that receive marks from the user specifying that the graphics are to be printed “with trimming” and “without borders,” and mark parts 9826 that receive marks from the user specifying that the graphics are to be printed “with trimming” and “with borders.”

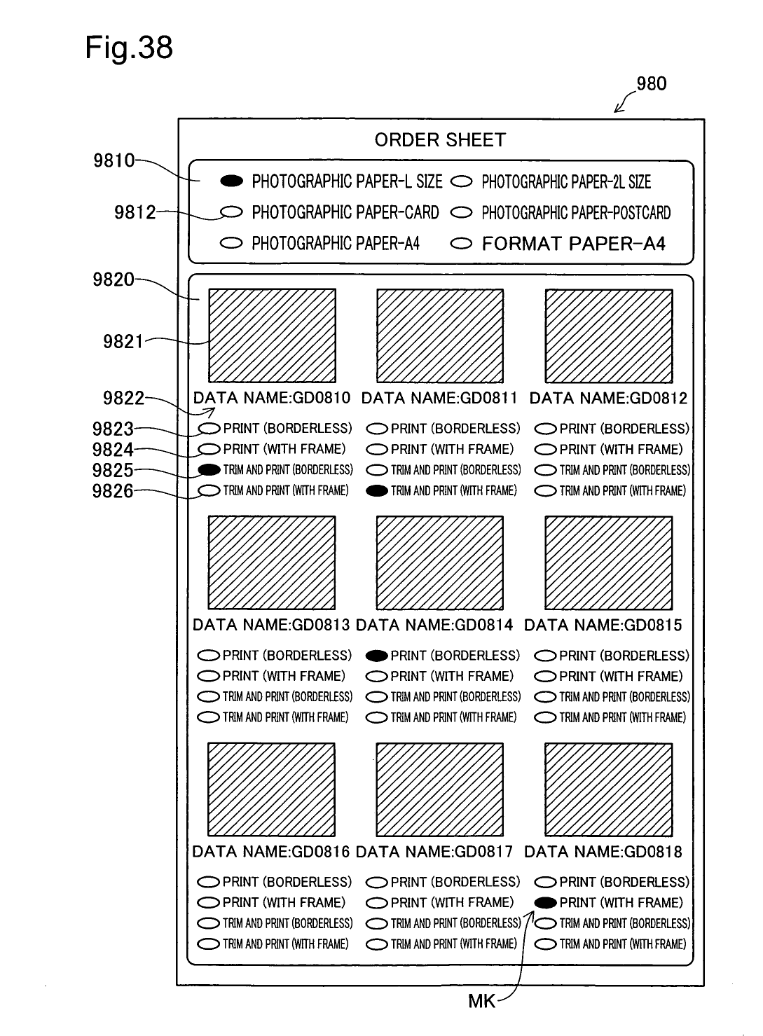

FIG. 38 is an explanatory diagram illustrating one example of an order sheet 980 in FIG. 37 wherein information for printing the graphics has been marked by the user according to the eighth example of embodiment. The order sheet 980 of FIG. 38 has, as information that is marked by the user for printing the graphics, a mark MK wherein the inside of one of the plurality of mark parts 9812 of the printing paper specifying area 9810 has been filled in, and marks MK, wherein mark parts 9823, 9824, 9825, and 9826 of the printing status specifying area 9820 have been filled in.

In the example in FIG. 38, the mark MK is marked in the mark part 9812 corresponding to “PHOTOGRAPHIC PAPER—L SIZE” in the printing paper specifying area 9810, and in the printing status specifying area 9820, a mark MK is marked in the mark part 9825, indicating “TRIM AND PRINT (BORDERLESS)” for the data name “GD0810,” the mark MK is marked in the mark part 9826, indicating “TRIM AND PRINT (WITH FRAME)” for the data name “GD0811,” the mark MK is marked for the mark part 9823, indicating “PRINT (BORDERLESS)” for the data name “GD0814,” and the mark MK is marked for the mark part 9824, indicating “PRINT (WITH FRAME)” for the data name “GD0818.”

Returning to the explanation of FIG. 36, after the printing of the order sheet 980, shown in FIG. 37 (Step S110), and the scanning of the order sheet 980, shown in FIG. 38, has been performed (Step S115), then the main control unit 110 of the printing device 10 senses, from the scanned graphics obtained from the scanner unit 130, the marks MK that are marked in the mark part 9812 of the printing paper specifying area 9810, and also senses the marks MK that are marked in the mark parts 9823, 9824, 9825, and 9826 of the printing status specifying area 9820 (Step S820).

After the marks MK have been sensed from the scanned graphics (Step S820), the main control unit 110 of the printing device 10 performs preparations for printing the graphic that is first in the sequence shown in the order sheet 980 (Step S130), and then determines whether or not the graphic that has been prepared is to be printed, or in other words, determines whether or not a mark MK has been sensed for any of the mark parts 9823, 9824, 9825, or 9826 (Step S140). If it is determined that the graphic that has been prepared is to be printed (Step S140), then a determination is made as to whether or not the marks MK have been sensed in the mark parts 9825 or 9826, which indicate “TRIM AND PRINT” (Step S850).

When it has been determined that a mark MK has been sensed in the mark part 9825 or 9826 (Step S850), then the main control unit 110 displays, on a display unit 160, the graphic with a trimming frame TF superimposed on the source graphic SG, and receives, through an input button unit 170, instructions from the user for adjusting the trimmed graphic TG (Step S860). Thereafter, if, of the mark parts 9825 and 9826, a mark MK is sensed in the mark part 9825, which indicates “borderless printing,” the main control unit 110 performs printing of the trimmed graphic TG, which has been adjusted, in a borderless state (Step S875). On the other hand, if, of the mark parts 9825 and 9826, the mark MK has been sensed in the mark part 9826, which indicates “print with a border,” then the main control unit 110 performs printing of the trimmed graphic TG, which has been adjusted, in a state that has a border (Step S877).

If a mark MK has been sensed in the mark part 9823, indicating “borderless printing” (Step S850 and Step S852), then the main control unit 110 prints the source graphic SG in a borderless state (Step S855). On the other hand, if the mark MK has been sensed in the mark part 9824, indicating “print with border” (Step S850 and Step S852), then the main control unit 110 prints the source graphic SG in a state that has a border (Step S857).

The graphing printing technology in the eighth example of embodiment, described above, makes it possible for the printing unit 10 to use an order sheet 980 to receive requirements from the user regarding whether or not “borderless printing” is required for the graphics to be printed. As a result, the graphic printing technology according to the eighth example of embodiment makes it possible to increase the convenience of printing of graphics using an order sheet.

Note that in the eighth example of embodiment, a situation was shown wherein a specification indicating whether or not “borderless printing” is required could be received for each individual graphic; however, as another example of embodiment, the specification as to whether or not “borderless printing” is required could be received once for all of the graphics shown on the order sheet. For example, an order sheet wherein a mark part that is labeled “PRINT ALL BORDERLESS” and a mark part that is labeled “PRINT ALL NORMAL” have been added may be used in the order sheet 970 shown in FIG. 33, so that a single specification as to whether or not to print borderless can be received for all the graphics at once.

### I. Other Examples of Embodiment

While examples of embodiment according to the invention have been described above, the invention is in no wise limited to the aforementioned examples of embodiment, but rather can, of course, be embodied in a variety of forms in a range that does not deviate from the spirit or intention of the invention. For example, two or more of the methods for specifying the trimming region, that is, the cut lines CL in the first example of embodiment, the filled-in region PO in the second example of embodiment, the line segments LS along the grid lines 9330 in the third example of embodiment, the pairs of tick marks S1C and SC2 and tick marks SC3 and SC4 in the fourth example of embodiment, and the tick marks SCv and SCh in the fifth example embodiment, may be combined to specify the trimming region in each of the examples of embodiment. Moreover, the modified example in the first example of embodiment may also be applied to the second through eighth examples of embodiment. Furthermore, the invention may be applied to a computer system that is provided with a personal computer, a printing device, and a scanner device, and may be applied to a case wherein graphic data that is stored on a personal computer is printed using a printing device.

What is claimed is:

1. A printing method for printing an image based on image data, the printing method comprising:
loading the image data from a storage medium in which the image data is stored;
printing an order sheet, wherein the order sheet includes an index image representing the loaded image data to receive from a user entry of information for printing the image;
recognizing the information entered on the order sheet via scanning the order sheet; and
printing a trim image based on the recognized entered information, wherein the trim image is made by trimming the image.

2. The printing method according to claim 1, wherein the printing the trim image includes specifying an area to be cut from the image for the trim image based on the recognized entered information.

3. The printing method according to claim 1, wherein:
the recognizing the entered information includes recognizing, as the entered information, a frame border which is drawn on the index image; and
the printing the trim image includes specifying, as an area to be cut from the image for the trim image, an area outside of the recognized drawn frame border in the index image.

4. The printing method according to claim 1, wherein:
the recognizing the entered information includes recognizing, as the entered information, an area which is painted out on the index image; and
the printing the trim image includes specifying, as an area to be cut from the image for the trim image, the recognized painted area in the index image.

5. The printing method according to claim 1, wherein:
the printing the order sheet includes drawing grid lines on the index image;
the recognizing the entered information includes recognizing, as the entered information, line segments which are drawn along the grid lines on the index image; and
the printing the trim image includes specifying, as an area to be cut from the image for the trim image, an area outside of a rectangle composed of the recognized drawn line segments in the index image.

6. The printing method according to claim 1, wherein:
the printing the order sheet includes providing a ruler along a side of the index image on the order sheet;
the recognizing the entered information includes recognizing, as the entered information, a scale which is marked on the ruler; and
the printing the trim image includes specifying, as an area to be cut from the image for the trim image, an area corresponding to the recognizing marked scale in the index image.

7. The printing method according to claim 1, wherein:
the printing the order sheet includes providing a pair of rulers along mutually perpendicular sides of the index image on the order sheet;
the recognizing the entered information includes recognizing, as the entered information, two pairs of scales which are marked on each of the rulers; and
the printing the trim image includes specifying, as an area to be cut from the image for the trim image, an area outside of a rectangle surrounded by perpendicular lines from each of the recognized marked two pairs of scales in the index image.

8. The printing method according to claim 1, wherein:
the printing the order sheet includes:
drawing a trimming pattern showing candidate for the printed trim image on the index image; and
providing a marking sections for receiving from the user marking of a mark corresponding to the trimming pattern;
the recognizing the entered information includes recognizing, as the entered information, the mark marked on the marking section; and
the printing the trim image includes specifying, as an area to be cut from the image for the trim image, an area outside of the trimming pattern corresponding to the recognized marked mark in the index image.

9. The printing method according to claim 5, wherein aspect ratio of a rectangle surrounded by the drawn grid lines is equal to an aspect ratio of the trim image to be printed.

10. The printing method according to claim 3, wherein the printing the order sheet includes adjusting at least one of brightness and color saturation of the index image printed on the order sheet according to accuracy of the recognizing the entered information.

11. The printing method according to claim 3, wherein the printing the order sheet includes adjusting thinning out print dots forming the index image printed on the order sheet.

12. The printing method according to claim 3, wherein the printing the trim image further includes warning the user when at least one of aspect ratio and size of the trim image fails to fulfill a reference value.

13. The printing method according to claim 3, wherein the printing the trim image further includes modifying at least one of aspect ratio and size of the trim image based on a reference value.

14. The printing method according to claim 1, wherein the recognizing the entered information includes recognizing the entered information based on the color difference between the order sheet when printed and the order sheet when scanned.

15. The printing method according to claim 1, wherein the recognizing the entered information includes recognizing the entered information based on a specific color on the scanned order sheet.

16. The printing method according to claim 1,
wherein the printing the trim image includes:
displaying the trim image prior to the printing the trim image; and
receiving modification to the trim image from the user prior to the printing the trim image.

17. A printing apparatus printing an image based on image data, the printing apparatus comprising:
an image loading unit that loads the image data from a storage medium in which the image data is stored;
an order sheet print control unit that controls printing an order sheet, wherein the order sheet includes an index image representing the loaded image data to receive from a user entry of information for printing the image;
a scan recognition unit that recognizes the information entered on the order sheet via scanning the order sheet; and
a trimming print control unit that controls printing a trim image based on the recognized entered information, wherein the trim image is made by trimming the image.

18. The printing apparatus according to claim 17, wherein the trimming print control unit includes a trimming specifying unit that specifies an area to be cut from the image for the trim image based on the recognized entered information.

19. A computer readable recording medium, in which a computer program is recorded, the computer program causing a computer to print an image based on image data, the computer program causing the computer to attain functions of:
loading the image data from a storage medium in which the image data is stored;
controlling printing an order sheet, wherein the order sheet includes an index image representing the loaded image data to receive from a user entry of information for printing the image;
recognizing the information entered on the order sheet via scanning the order sheet; and
controlling printing a trim image based on the recognized entered information, wherein the trim image is made by trimming the image.

20. The computer readable recording medium according to claim 19, the computer program further causing the computer to attain a function of specifying an area to be cut from the image for the trim image based on the recognized entered information.
